(19) United States
(12) Patent Application Publication
(10) Pub. No.: US 2009/0222247 A1
(43) Pub. Date: Sep. 3, 2009

(54) SYSTEM FOR DETERMINING BASAL RATE PROFILES

(76) Inventors: Robert Hellwig, Bern (CH); Wim Van der Helm, Zurich (CH); Stefan Weinert, Pendleton, IN (US)

Correspondence Address: BARNES & THORNBURG LLP (Roche), 11 SOUTH MERIDAN STREET, INDIANAPOLIS, IN, 46204, US

(21) Appl. No.: 12/039,366

(22) Filed: Feb. 28, 2008

(51) Int. Cl. G06G 7/60

(52) U.S. Cl. 703/11

(57) ABSTRACT

A system and method are provided for generating a plurality of basal rate models that together model delivery of a corresponding plurality of basal rates of a diabetes treatment drug to a patient over a period of time. Information may be collected from a plurality of patients that have a diabetic condition and to which the diabetes treatment drug has been delivered. The collected information may include a glycemic control indicator for each of the plurality of patients that is indicative of an efficacy of the diabetes treatment drug in treating the patient's diabetic condition. The collected information may be filtered based on the glycemic control indicators to produce a subset of information that includes information only for patients that exhibit acceptable glycemic control. The plurality of basal rate models may be generated based on the subset of the collected information, and may be stored in a memory unit.

### FIELD OF THE INVENTION

The present invention relates generally to systems for determining drug administration profiles, and more specifically to systems for determining basal rate profiles for the administration of one or more diabetes therapy drugs.

### BACKGROUND

Many patients having a diabetic condition are required to receive a diabetes therapy or treatment drug one or more times per day. Some such patients are required to receive several doses of the diabetes therapy or treatment drug periodically throughout the day and night. With such patients, a basal rate profile may be designed that defines a number of sequential doses, or basal rates, of the diabetes treatment drug that are administered to the patient over a period of time. For example, a conventional basal rate profile may consist of 24 separate basal rates, each having a duration of one hour, that are designed to be sequentially administered to the patient over successive 24-hour time periods. It is desirable to design basal rate profiles that are based on patient-specific medical parameters and that have proven to successfully treat diabetic conditions of a significant number of patients.

### SUMMARY

The present invention may comprise one or more of the features recited in the attached claims, and/or one or more of the following features and combinations thereof. A method is provided for generating a plurality of basal rate models that together model delivery of a corresponding plurality of basal rates of a diabetes treatment drug to a patient over a period of time. The method may comprise collecting information from a plurality of patients that have a diabetic condition and to which the diabetes treatment drug has been delivered. The collected information may include a glycemic control indicator for each of the plurality of patients that is indicative of an efficacy of the diabetes treatment drug in treating the patient's diabetic condition. The method may further comprise filtering the collected information based on the glycemic control indicators to produce a subset of the collected information that includes information only for patients that exhibit acceptable glycemic control, generating the plurality of basal rate models based on the subset of the collected information, and storing the generated plurality of basal rate models in a memory unit.

The collected information may include values of the basal rates of the diabetes treatment drug delivered to each of the plurality of patients over the period of time. Generating the plurality of basal rate models may comprise generating the plurality of basal rate models based, at least in part, on the values of the plurality of basal rates of the diabetes treatment drug delivered to each of the plurality of patients in the subset of the collected information.

The collected information may include a plurality of categorical patient parameters for each of the plurality of patients. Each of the plurality of categorical patient parameters for each of the plurality of patients may have one of two or more possible values or ranges. The method may further comprise partitioning the subset of the collected information into a number of different patient information subgroups each identified by a different combination of the two or more possible values or ranges of at least two of the plurality of categorical patient parameters. Generating the plurality of basal rate models may comprise generating the plurality of basal rate models based on at least one of the number of different patient information subgroups. The at least two of the plurality of categorical patient parameters may be selected from the group of patient gender, diabetes type, pre-dawn phenomenon, patient age, patient height, patient weight, body mass index and diabetes treatment drug delivery mechanism. The one of two or more possible values or ranges of the categorical patient parameter patient gender may be selected from the group of male and female. The one of two or more possible values or ranges of the categorical patient parameter diabetes may be selected from the group of type 1, type 2, gestational, latent autoimmune diabetes in adults (LADA), brittle, impaired fasting glucose (IFG) and impaired glucose tolerance (IGT). The one of two or more possible values or ranges of the categorical patient parameter pre-dawn phenomenon may be selected from the group of patient experiences the pre-dawn phenomenon and the patient does not experience the pre-dawn phenomenon. The one of two or more possible values or ranges of the categorical patient parameter patient age may be selected from a group of non-overlapping age ranges. The one of two or more possible values or ranges of the categorical patient parameter patient height may be selected from a group of non-overlapping height ranges. The one of two or more possible values or ranges of the categorical patient parameter patient weight may be selected from a group of non-overlapping weight ranges. The one of two or more possible values or ranges of the categorical patient parameter body mass index may be selected from a group of non-overlapping body mass index ranges. The one of two or more possible values or ranges of the categorical patient parameter diabetes treatment drug delivery mechanism may be selected from the group of needle, infusion pump, insulin pen and inhalable insulin. The method may further comprise generating a number of sets of basal rate models. Each of the number of sets of basal rate models may comprise a plurality of basal rate models that are generated based on a different one of the number of different patient information subgroups. The method may further comprise storing each of the generated number of sets of basal rate models in the memory unit.

The collected information may comprise a plurality of patient records each for a different one of the plurality of patients. Each of the plurality of patient records may include a reference time within the period of time and a basal rate profile defining a plurality of basal rates of the diabetes treatment drug sequentially delivered to the corresponding patient over the period of time beginning with a first basal rate and ending with a last basal rate. The method may further comprise aligning the basal rate profiles in the plurality of patient records as functions of the reference times such that in each of the plurality of patient records the first basal rate of the corresponding basal rate profile begins at the corresponding reference time. Filtering the collected information may comprise filtering the collected information after aligning the basal rate profiles in the plurality of patient records. Each of the plurality of patient records may further include a start time that corresponds to a time within the period of time that the first basal rate of the corresponding basal rate profile normally begins. Aligning the basal rate profiles may further comprise aligning the basal rate profiles in the plurality of patient records further as functions of the start times such that in each of the patient records the first basal rate of the corresponding basal rate profile begins at the corresponding reference time regardless of the corresponding start time. In any case, the reference time in each of the plurality of patient records may be a time within the period of time that the corresponding patient normally falls asleep.

A method of generating a plurality of basal rate models that together model delivery of a corresponding plurality of basal rates of a diabetes treatment drug to a patient over a period of time may comprise collecting information from a plurality of patients to which the diabetes treatment drug has been delivered. The collected patient information may include a plurality of categorical patient parameters for each of the plurality of patients. Each of the plurality of categorical patient parameters for each of the plurality of patients may have one of two or more possible values or ranges. The method may further comprise partitioning the collected information into a number of different patient information subgroups each identified by a different combination of the two or more possible values or ranges of at least two of the plurality of categorical patient parameters, generating the plurality of basal rate models based on the collected information in at least one of the number of different patient information subgroups, and storing the generated plurality of basal rate models in a memory unit.

The at least two of the plurality of categorical patient parameters may be selected from the group of patient gender, diabetes type, pre-dawn phenomenon, patient age, patient height, patient weight, body mass index and diabetes treatment drug delivery mechanism. The one of two or more possible values or ranges of the categorical patient parameter patient gender may be selected from the group of male and female. The one of two or more possible values or ranges of the categorical patient parameter diabetes may be selected from the group of type 1, type 2, gestational, latent autoimmune diabetes in adults (LADA), brittle, impaired fasting glucose (IFG) and impaired glucose tolerance (IGT). The one of two or more possible values or ranges of the categorical patient parameter pre-dawn phenomenon may be selected from the group of patient experiences the pre-dawn phenomenon and the patient does not experience the pre-dawn phenomenon. The one of two or more possible values or ranges of the categorical patient parameter patient age may be selected from a group of non-overlapping age ranges. The one of two or more possible values or ranges of the categorical patient parameter patient height may be selected from a group of non-overlapping height ranges. The one of two or more possible values or ranges of the categorical patient parameter patient weight may be selected from a group of non-overlapping weight ranges. The one of two or more possible values or ranges of the categorical patient parameter body mass index may be selected from a group of non-overlapping body mass index ranges. The one of two or more possible values or ranges of the categorical patient parameter diabetes treatment drug delivery mechanism may be selected from the group of needle, infusion pump, insulin pen and inhalable insulin. The method may further comprise generating a number of sets of the plurality of basal rate models each based on the collected information in a different one of the number of different patient information subgroups. The method may further comprise storing the generated number of sets of the plurality of basal rate models in the memory unit.

The collected information may include a plurality of medical condition indicators each indicative of a medical condition of a different one of the plurality of patients. The method may further comprise filtering the collected information based on the plurality of medical condition indicators to produce a subset of the collected information that includes patient information only for patients for which the corresponding medical condition is acceptable. Partitioning the collected information into a number of different patient information subgroups may comprise partitioning the collected information from the subset of the collected information into the number of different patient subgroups.

The collected information may comprise a plurality of patient records each for a different one of the plurality of patients. Each of the plurality of patient records may include a reference time within the period of time and a basal rate profile defining a plurality of basal rates of the diabetes treatment drug sequentially delivered to the corresponding patient over the period of time beginning with a first basal rate and ending with a last basal rate. The method may further comprise aligning the basal rate profiles in the plurality of patient records as functions of the reference times such that in each of the plurality of patient records the first basal rate of the corresponding basal rate profile begins at the corresponding reference time. Filtering the collected information may comprise filtering the collected information after aligning the basal rate profiles in the plurality of patient records. Each of the plurality of patient records may further include a start time that corresponds to a time within the period of time that the first basal rate of the corresponding basal rate profile normally begins. Aligning the basal rate profiles may further comprise aligning the basal rate profiles in the plurality of patient records further as functions of the start times such that in each of the patient records the first basal rate of the corresponding basal rate profile begins at the corresponding reference time regardless of the corresponding start time. In any case, the reference time in each of the plurality of patient records may be a time within the period of time that the corresponding patient normally falls asleep.

A method of generating a plurality of basal rate models that together model a basal rate profile defining a corresponding plurality of basal rates of a diabetes treatment drug sequentially delivered to a patient over a period of time beginning with a first basal rate and ending with a last basal rate may comprise collecting information in the form of a plurality of patient records each for a different patient to which the diabetes treatment drug has been delivered. Each of the plurality of patient records may include a reference time within the period of time and a basal rate profile that are specific to the corresponding patient. The method may further comprise aligning the basal rate profiles in the plurality of patient records as functions of the reference times such that in each of the plurality of patient records the first basal rate of the corresponding basal rate profile begins at the corresponding reference time, generating the plurality of basal rate models based on the patient records having aligned basal rate profiles, and storing the generated plurality of basal rate models in a memory unit.

The reference time in each of the plurality of patient records may be a time within the period of time that the corresponding patient normally falls asleep. Each of the plurality of patient records may further include a start time that corresponds to a time within the period of time that the first basal rate of the corresponding basal rate profile normally begins. Aligning the basal rate profiles further comprises aligning the basal rate profiles in the plurality of patient records further as functions of the start times such that in each of the patient records the first basal rate of the corresponding basal rate profile begins at the corresponding reference time regardless of the corresponding start time. The period of time may be twenty four hours in duration. The basal rate profile in each of the plurality of patient records may comprise twenty four basal rates each having a time duration of one hour.

The collected information may include a plurality of categorical patient parameters for each of the plurality of patients. Each of the plurality of categorical patient parameters for each of the plurality of patients may have one of two or more possible values or ranges. The method may further comprise partitioning the subset of the collected information into a number of different patient information subgroups each identified by a different combination of the two or more possible values or ranges of at least two of the plurality of categorical patient parameters. Generating the plurality of basal rate models may comprise generating the plurality of basal rate models based on at least one of the number of different patient information subgroups. The at least two of the plurality of categorical patient parameters may be selected from the group of patient gender, diabetes type, pre-dawn phenomenon, patient age, patient height, patient weight, body mass index and diabetes treatment drug delivery mechanism. The one of two or more possible values or ranges of the categorical patient parameter patient gender may be selected from the group of male and female. The one of two or more possible values or ranges of the categorical patient parameter diabetes may be selected from the group of type 1, type 2, gestational, latent autoimmune diabetes in adults (LADA), brittle, impaired fasting glucose (IFG) and impaired glucose tolerance (IGT). The one of two or more possible values or ranges of the categorical patient parameter pre-dawn phenomenon may be selected from the group of patient experiences the pre-dawn phenomenon and the patient does not experience the pre-dawn phenomenon. The one of two or more possible values or ranges of the categorical patient parameter patient age may be selected from a group of non-overlapping age ranges. The one of two or more possible values or ranges of the categorical patient parameter patient height may be selected from a group of non-overlapping height ranges. The one of two or more possible values or ranges of the categorical patient parameter patient weight may be selected from a group of non-overlapping weight ranges. The one of two or more possible values or ranges of the categorical patient parameter body mass index may be selected from a group of non-overlapping body mass index ranges. The one of two or more possible values or ranges of the categorical patient parameter diabetes treatment drug delivery mechanism may be selected from the group of needle, infusion pump, insulin pen and inhalable insulin. The collected information may include a plurality of medical condition indicators each indicative of a medical condition of a different one of the plurality of patients. The method may further comprise filtering the collected information based on the plurality of medical condition indicators to produce a subset of the collected information that includes patient information only for patients for which the corresponding medical condition is acceptable. Aligning the basal rate profiles in the plurality of patient records may comprise aligning the basal rate profiles only in patient records included in the subset of the collected information.

A method of determining a set of basal rate models that define delivery of a diabetes treatment drug to a particular patient over a period of time may comprise collecting information from a plurality of patients to which the diabetes treatment drug has been delivered, generating a number of sets of basal rate models based on the information collected from the plurality of patients, collecting information that is specific to the particular patient, determining the set of basal rate models for the particular patient based on the number of sets of basal rate models and on the collected information that is specific to the particular patient, and storing the determined set of basal rate models for the particular patient in a memory unit.

The information collected from the plurality of patients may include a plurality of categorical patient parameters for each of the plurality of patients. The method may further comprise partitioning the information collected from the plurality of patients into a number of different patient information subgroups each identified by a different combination of the plurality of categorical patient parameters. Generating the number of sets of basal rate models may comprise generating each of the number of sets of basal rate models based on a different one of the number of different patient information subgroups. Collecting information that is specific to the particular patient may comprise collecting the plurality of categorical patient parameters for the particular patient. Determining the set of basal rate models for the particular patient may comprise selecting from the number of sets of basal rate models a set of basal rate models that was based on a plurality of the categorical patient parameters that most closely matches the plurality of categorical patient parameters for the particular patient. Generating a number of sets of basal rate models based on the information collected from the plurality of patients may be carried out on a first electronic device or system. Collecting information that is specific to the particular patient and determining the set of basal rate models for the particular patient may be carried out on a second electronic device that is remote from the first electronic device or system. Storing the determined set of basal rate models for the particular patient may comprise storing the determined set of basal rate models for the particular patient in a memory unit of the second electronic device.

The method may further comprise delivering the diabetes treatment drug to the particular patient according to the set of basal rate models for the particular patient over successive time periods each having duration equal to the period of time.

A method is provided for generating a basal rate profile that defines delivery of a plurality of basal rates of a diabetes treatment drug to a particular patient over a period of time. The method may comprise collecting information from a plurality of patients to which the diabetes treatment drug has been delivered, and generating a plurality of basal rate model sets based on the information collected from the plurality of patients. Each of the plurality of basal rate model sets may model delivery of a different plurality of basal rates of the diabetes treatment drug to a patient over the period of time. The method may further comprise collecting a first set of information that is specific to the particular patient, selecting one of the plurality of basal rate model sets based on the first set of information that is specific to the particular patient, collecting a second set of information that is specific to the particular patient, generating the basal rate profile based on the selected one of the plurality of basal rate model sets and on the second set of information that is specific to the particular patient, and storing the generated basal rate profile in a memory unit.

The information collected from the plurality of patients may include a plurality of categorical patient parameters for each of the plurality of patients. The method may further comprise partitioning the information collected from the plurality of patients into a number of different patient information subgroups each identified by a different combination of the plurality of categorical patient parameters. Generating the plurality of basal rate model sets may comprise generating each of the plurality of basal rate model sets based on a different one of the number of different patient information subgroups. Collecting a first set of information that is specific to the particular patient may comprise collecting the plurality of categorical patient parameters for the particular patient. Selecting one of the plurality of basal rate model sets based on the first set of information that is specific to the particular patient may comprise selecting from the plurality of basal rate model sets the one of the plurality of basal rate model sets that was based on a plurality of the categorical patient parameters that most closely matches the plurality of categorical patient parameters for the particular patient. Collecting a second set of information that is specific to the particular patient may comprise collecting a number of independent variables that are specific to the particular patient. Generating the basal rate profile may comprise computing a plurality of basal rates of the diabetes treatment drug to be sequentially delivered to the particular patient over successive time periods each having duration equal to the period of time. Each of the plurality of basal rates of the diabetes treatment drug may be based on a different basal rate model of the selected one of the plurality of basal rate model sets and on the number of independent variables that are specific to the particular patient. The method may further comprise sequentially delivering the plurality of basal rates of the diabetes treatment drug to the particular patient over each of the successive time periods.

Generating a plurality of basal rate model sets based on the information collected from the plurality of patients may be carried out on a first electronic device or system. Collecting the first set of information, selecting the one of the plurality of basal rate model sets, collecting the second set of information and generating the basal rate profile may be carried out on a second electronic device that is remote from the first electronic device or system. Storing the generated basal rate profile may comprise storing the generated basal rate profile in a memory unit of the second electronic device.

Still another method is provided for generating a plurality of basal rate models that together model delivery of a corresponding plurality of basal rates of a diabetes treatment drug to a patient over a period of time. The method may comprise collecting patient information from a plurality of patients to which the diabetes treatment drug has been delivered, partitioning the collected patient information into a calibration data subset and a validation data subset, generating the plurality of basal rate models based on the calibration data subset, determining whether the plurality of basal rate models are valid by processing the validation data subset using the plurality of basal rate models that were generated based on the calibration data subset, and storing the generated plurality of basal rate models in a memory unit if the plurality of basal rate models that were generated based on the calibration data subset are valid.

### BRIEF DESCRIPTION OF THE DRAWINGS

FIG. 1 is a block diagram of one illustrative embodiment of a system for determining basal rate profiles.

FIG. 2 is a flowchart of one illustrative embodiment of a process for generating a plurality of basal rate models based on information collected from a plurality of patients.

FIG. 3 is a flowchart of one illustrative embodiment of step 104 of the process illustrated in FIG. 2.

FIG. 4 is a flowchart of one illustrative embodiment of step 110 of the process illustrated in FIG. 2.

FIG. 5 is a flowchart of one illustrative embodiment of step 154 of the process illustrated in FIG. 4.

FIG. 6 is a flowchart of one illustrative embodiment of step 158 of the process illustrated in FIG. 4.

FIG. 7 is a flowchart of one illustrative embodiment of step 160 of the process illustrated in FIG. 4.

FIG. 8 is a flowchart of one illustrative embodiment of a process for determining patient-specific basal profiles based on a plurality of basal rate models and on patient-specific information.

FIG. 9 is a flowchart of one illustrative embodiment of step 318 of the process of FIG. 8.

### DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same.

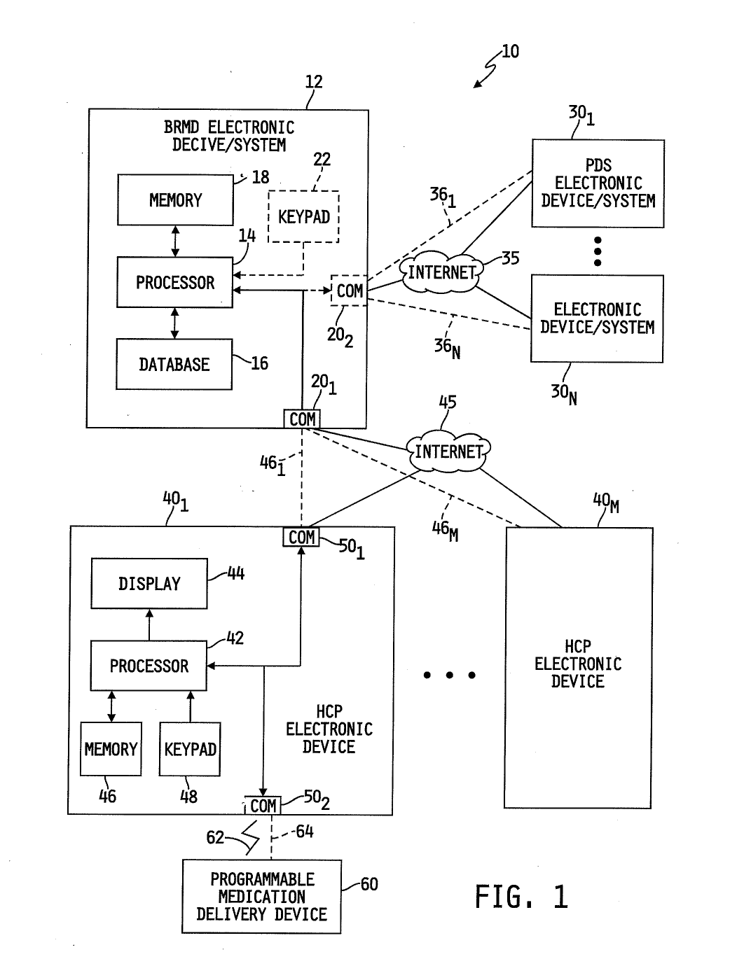

Referring to FIG. 1, a block diagram is shown of one illustrative embodiment of a system 10 for determining basal rate profiles. In the illustrated embodiment, the system 10 includes a basal rate model development (BRMD) electronic device or system 12 having a conventional processor 14 that is operatively coupled to a database 16 and to a conventional memory unit 18. The BRMD electronic device/system 12 includes at least one conventional communication port 20₁ that is operatively coupled to the processor 14, and which may be configured for wired and/or wireless communication with one or more other electronic devices or systems, such as any number, M, of health care professional (HCP) electronic devices 40₁-40_{M}, where M may be any positive integer. In some embodiments, the BRMD electronic device/system 12 may further include another conventional communication port 20₂, as shown in phantom in FIG. 1, that is operatively coupled to the processor 14 and which may be configured for wired or wireless communication with one or more other electronic devices or systems, such as any number, N, of patient data source (PDS) electronic devices or systems 30₁-30_{N}, where N may be any positive integer. In some embodiments, the BRMD electronic device/system 12 may further include a conventional keypad or keyboard 22 that is operatively coupled to the processor 14. The BRMD electronic device/system 12 may be a conventional electronic device or system. Examples of the BRMD electronic device/system 12 include, but are not limited to, one or more personal computers (PCs), a server-based computer system, a networked system of conventional personal computers, laptop computers and/or notebook computers, or the like.

The one or more patient data source (PDS) electronic devices or systems 30₁-30_{N} may likewise be conventional. Examples include, but are not limited to, one or more personal computers (PCs), laptop computers, notebook computers, hand-held electronic devices such as a personal data assistant (PDA), smart-phones or the like. Illustratively, each of the one or more PDS electronic devices/systems 30₁-30_{N} is configured to wirelessly communicate with the BRMD electronic device/system 12 via the internet, e.g., world-wide-web (WWW) 35, although each of the one or more PDS electronic devices/systems 30₁-30_{N} may alternatively be configured to wirelessly communicate with the BRMD electronic device/system 12 via one or more other wireless communication mediums such as cellular telephone or telephone modem. Alternatively still, each of the one or more PDS electronic devices/systems 30₁-30_{N} may be configured to communicate with the BRMD electronic device/system 12 via one or more corresponding hardwire signal paths 36₁-36_{N}.

Each of the one or more health care professional (HCP) electronic devices 40₁-40_{M} includes a conventional processor 42 that is operatively coupled to a conventional display 44, a conventional memory 46, a conventional keypad or keyboard 48 and at least two conventional communication ports 50₁ and 50₂. Illustratively, each of the one or more HCP electronic devices 40₁-40_{M} may be co-located with a different health care professional or different health care professional facility. Examples of the one or more HCP electronic devices 40₁-40_{M} include, but are not limited to, one or more personal computers (PCs), laptop computers, notebook computers, hand-held electronic devices such as a personal data assistant (PDA) or the like. Illustratively, each of the one or more HCP electronic devices 40₁-40_{M} is configured to wirelessly communicate with the BRMD electronic device/system 12 via the internet, e.g., world-wide-web (WWW) 45, although each of the one or more HCP electronic devices 40₁-40_{M} may alternatively be configured to wirelessly communicate with the BRMD electronic device/system 12 via one or more other wireless communication mediums, such as cellular telephone or telephone modem. Alternatively still, each of the one or more HCP electronic devices 40₁-40_{M} may be configured to communicate with the BRMD electronic device/system 12 via one or more corresponding hardwire signal paths 46₁-46_{M}. Each of the HCP electronic devices 40₁-40_{M} is further configured to wirelessly communicate with a conventional programmable medication delivery device 60 via a conventional wireless communication protocol, e.g., radio frequency (RF), inductive coupling, infrared (IR), or the like. Alternatively, each of the one or more HCP electronic devices 40₁-40_{M} may be configured to communicate with a programmable medication delivery device 60 via a hardwire signal paths 60. The programmable medication delivery device may be any conventional electronically controlled medication delivery device, and examples include, but are not limited to, an implantable drug infusion pump, an externally worn drug infusion pump, or the like.

As will be described in greater detail hereinafter, the system 10 illustrated in FIG. 1 is configured to collect patient information that relates to the delivery of a diabetes treatment drug over a specified period of time via a plurality of individual basal rates that span the period of time, to process the collected patient information to create a plurality of sets of basal rate models and to generate sets of patient-specific basal rates based on appropriately matched ones of the sets of basal rate models. As it relates to the system 10 illustrated in FIG. 1, the collected patient information is generally processed to create a plurality of sets of basal rate models using the BRMD electronic device/system 12, although any one or more of the illustrated devices and/or systems may be used to collect the patient information and provide the collected patient information to the BRMD electronic device/system 12. For example, the patient information may be provided by patients currently undergoing diabetes therapy via the one or more PDS electronic devices/systems 30₁-30_{N}. In this embodiment, patients currently undergoing diabetes therapy may provide the patient information to the database 16 of the BRMD electronic device/system 12 via an internet-accessible or otherwise accessible survey or other questionnaire. As another example, the patient information may be provided by patients currently undergoing diabetes therapy to an operator of the BRMD electronic device/system 12, and the operator the BRMD electronic device/system 12 may then enter the patient information into the database 16 via the keypad or keyboard 22 or other data entry device. In this embodiment, patients currently undergoing diabetes therapy may provide the patient information to the one or more operators of the BRMD electronic device/system 12 via paper mail, telephone or the like, and the one or more operators of the BRMD electronic device/system 12 may then enter the patient information into the database 16. As still another example, the patient information may be provided by one or more health care professionals to the BRMD electronic device/system 12 via the one or more HCP electronic devices 40₁-40_{M}. In this embodiment, health care professionals treating patients that are currently undergoing diabetes therapy may provide the patient information to the database 16 of the BRMD electronic device/system 12 via an internet-accessible or otherwise accessible survey or other questionnaire.

Once collected in the database 16 of the BRMD electronic device/system 12, the patient information is processed by the BRMD electronic device/system 12 to create the plurality of sets of basal rate model sets. Thereafter, health care professionals may access the BRMD electronic device/system 12 via the HCP electronic devices 40₁-40_{M}, and use appropriate ones of the plurality of basal rate model sets to generate patient-specific basal rate profiles.

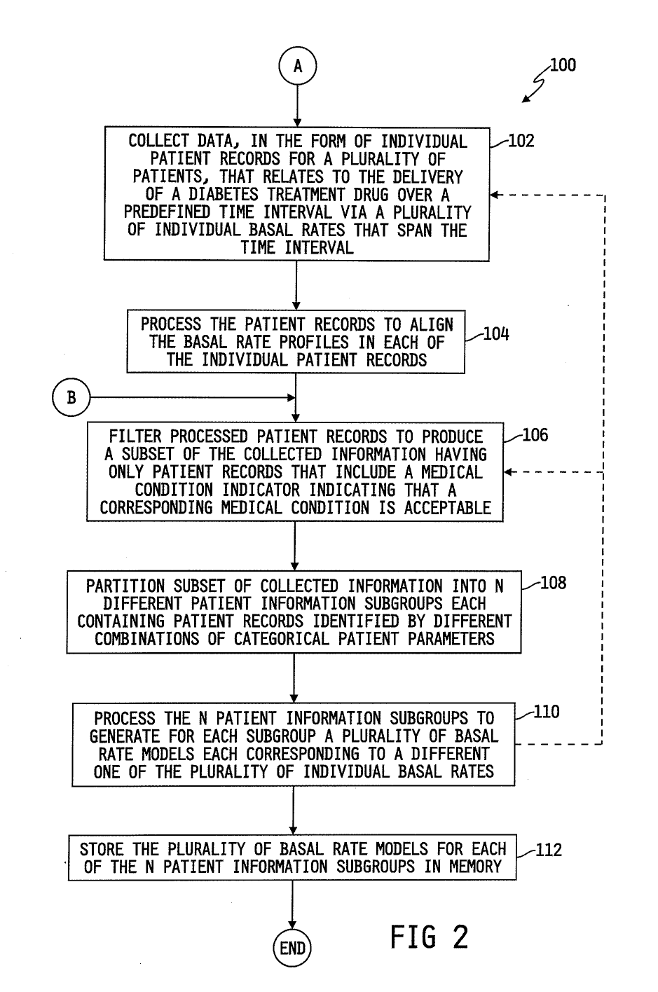

Referring now to FIG. 2, a flowchart is shown of one illustrative embodiment of a process 100 for generating a plurality of basal rate models based on information collected from a plurality of patients. Illustratively, the process 100 may be carried out using only the basal rate model determination (BRMD) electronic device or system 12, although at least the information collection aspect of the process 100 may alternatively be carried out using one or more of the patient data source (PDS) electronic devices and/or systems 30₁-30_{N}, one or more of the health care professional (HCP) electronic devices 40₁-40_{M} and/or one or more other conventional electronic devices or systems. In embodiments of the process 100 in which the information collection aspect is carried out using an electronic device or system other than the BRMD electronic device or system 12, such information is collected and/or stored on a suitable electronic device or system, and then transferred to the BRMD electronic device or system 12 via wired or wireless data transfer.

The process 100 may have multiple entry points, and one such entry point is an entry point A that leads to step 102 of the process 100. At step 102, information is collected from a plurality of patients that have a diabetic condition and to which a diabetes treatment drug has been delivered. Illustratively, the plurality of patients from which information is collected at step 102 comprises a large population of patients to which a diabetes treatment drug has been delivered. The diabetes treatment drug may be any conventional drug that is effective to modify, e.g., raise or lower, blood glucose levels, and that may be delivered using any conventional drug delivery structures and/or techniques. Examples of conventional diabetes treatment drugs may include, but should not be limited to, insulin and the like, and examples of conventional drug delivery structures and/or techniques include, but should not be limited to, subcutaneous drug delivery mechanisms including hypodermic needles, drug dosing pens, implanted or externally worn electronically or electromechanically controlled drug delivery mechanisms such as drug infusion pumps, and the like, transcutaneous drug delivery mechanisms including drug patches or the like, inhalable drugs or the like.

In one illustrative embodiment, the information or data is collected at step 102 in the form of individual patient records for each of the plurality of patients, wherein each of the plurality of individual patient records contains disease-related information, drug-related information, personal information and/or other information that is specific to the particular patient. For example, each patient record illustratively contains information that relates to the delivery of a diabetes treatment drug over a predefined time interval via a plurality of individual and sequentially delivered basal rates of the drug that span the predefined time interval. Illustratively, the predefined time interval may be 24 hours, and the plurality of basal rates may be one hour (60 minutes) in duration, although this disclosure contemplates other embodiments having different predefined time intervals and/or basal rate durations. It will be understood that while several embodiments and accompanying formulae will be described in this document, such embodiments and formulae are provided only by way of example. Modifications to these example embodiments and formulae to provide for time interval durations other than 24 hours and/or basal rate durations other than 60 minutes may be required, although such modifications will generally be a mechanical step or steps for someone skilled in the art. In any case, the patient information collection step 102 can be carried out in any format, e.g., xml, html, or the like, using any conventional data collection device, machine or system.

Illustratively, the information collected at step 102 comprises categorical patient information, i.e., one or more categorical patient parameters, each of which places a patient in one of a number of categories, and further comprises drug delivery-related information, medical condition indication information, e.g., one or more indicators of the patient's general or specific health, and one or more patient-specific independent variables. Illustratively, the one or more of the categorical patient parameters may place a patient in either of two categories, and others of the categorical patient parameters may place a patient in one of more than two categories. In other words, each of the categorical patient parameters for each patient will have one of two or more possible values or ranges. Examples of categorical patient parameters that may be collected at step 102 and that place a patient in one of two categories may include, but should not be limited to, patient gender, e.g., male or female, diabetes type, e.g., type 1 or type 2, whether or not a patient experiences the so-called pre-dawn or dawn phenomenon, e.g., yes or no, and the like. For purposes of this disclosure, the pre-dawn or dawn phenomenon is defined as being characterized by an early morning elevated blood glucose resulting from changes in glucose metabolism during sleep. It is generally known that some diabetic patients experience this phenomenon while others do not. Examples of categorical patient parameters that may be collected at step 102 and that place a patient in one of more than two categories may include, but should not be limited to, patient age, e.g., grouped by a number of non-overlapping age ranges, diabetes type, e.g., type 1, type 2, gestational, latent autoimmune diabetes in adults (LADA), brittle, impaired fasting glucose (IFG), impaired glucose tolerance (IGT) or other, patient height, e.g., grouped by a number of non-overlapping height ranges, patient weight, e.g., grouped by a number of non-overlapping weight ranges, body mass index (BMI), e.g., grouped by a number of non-overlapping BMI ranges, diabetes treatment drug delivery mechanism, e.g., needle, infusion pump, insulin pen, inhalable insulin, and the like.

Examples of drug delivery-related information that may be collected and included in the individual patient records may include, but should not be limited to, diabetes treatment drug delivery mechanism, e.g., needle, infusion pump, continuous subcutaneous insulin infusion, insulin pen, inhalable insulin, elapsed time on current diabetes treatment drug mechanism, e.g., days and/or years since started, current insulin pump configuration times and/insulin type, e.g., fast-acting or slow-acting, total daily dose (TDD) of diabetes treatment drug, current basal rate profile, basal rate philosophy, basal rate profile start time, insulin pump type, elapsed time on current basal rate, e.g., date started or elapsed time since last basal rate change, or the like.

Examples of medical condition indication information that may be collected and included in the individual patient records may include, but should not be limited to, Hb1AC or other measure of glycemic control or other measure of the efficacy of the current diabetes therapy, average daily, weekly or monthly blood glucose level, or the like. For purposes of this disclosure, the term HbA1C is defined as a measure of glycated hemoglobin, which is typically used as a long-running average of blood glucose levels. Examples of patient-specific independent variables that may be collected and included in the individual patient records may include, but should not be limited to, patient age, patient height, patient weight, body mass index (BMI), country of residence, elapsed time having diabetes, e.g., age diagnosed, years since onset of diabetes, etc., pregnancy, e.g., whether currently pregnant or not currently pregnant, date of conception, dates of previous pregnancy or pregnancies, number of pregnancies, etc., regular time of falling asleep, regular time of waking, patient exercise schedule and/or frequency of exercise and/or duration and/or classification of exercise, e.g., light, medium or extended, and the like.

From step 102, the process 100 advances to step 104 where the plurality of patient records collected at step 102 are processed to align the basal rate profiles in each of the individual patient information records. Generally, a basal rate profile is made up of a number of sequential delivery rates of a diabetes treatment drug that begin with a first basal rate and end with a last basal rate. At step 104, the plurality of patient records are processed in a manner that aligns the basal rate profiles of each of the plurality of patients so that the first basal rate in each patient record begins at a reference time that is specific to that patient.

As described by example above, conventional programmable diabetes treatment drug delivery mechanisms, such as implantable or externally worn insulin pumps and the like, allow for the basal rate profile to be defined in the form of 24 individually programmable diabetes treatment drug infusion rates each having a duration of one hour. Many, but not all, such programmable drug delivery mechanisms define the first of the 24 one-hour intervals as beginning at midnight. In any case, the use of such a 24-hour basal rate profile reflects an assumption of an underlying circadian rhythm in the body's basal insulin needs. In any given patient record, the basal rate profile should therefore be expected to show a phase shift that is determined by the patient's sleep/wake rhythm relative to the starting time of the first basal rate in the patient's basal rate profile. At step 104, the plurality of patient information records are processed to remove this phase shift so that the basal rate profiles of the plurality of patients from which information was collected at step 102 are aligned and can therefore be piecewise modeled as a function of macroscopic parameters.

Illustratively, because the circadian rhythm is closely tied to a patient's sleep/wake cycle, the patient records are processed at step 104 by aligning the basal rate profiles in each patient record so that the first basal rate in each of the patient records begins at either the patient's normal sleep time or wake time. Alternatively, the patient records may be processes at step 104 by aligning the basal rate profiles in each patient record so that the first basal rate in each of the patient records begins at another reference time that is patient specific and that may differ between patients. In either case, aligning of the basal rate profiles relative to a reference time may further take into account the timing of other patient-related events or activities, examples of which may include, but should not be limited to, timing of a female menstrual cycle, seasonal or other timing of exercise types and/or durations, e.g., fall/winter indoor exercise activity types and durations vs. spring/summer outdoor exercise activity types and durations, seasonal or other timing of physiological conditions, e.g., seasonal allergies, seasonal asthmatic conditions, etc., or the like.

In the example that follows, step 104 will be described as aligning the basal rate profiles in each of the plurality of patient records so that the first basal rate in each patient records begins at the patient's normal sleep time, although it will be understood that step 104 may alternatively be configured to align the basal rate profiles in each patient record so that the first basal rate in each patient record begins at the patient's normal wake time or, alternatively still, at another reference time that is specific to each patient and which may be different for some patients as compared with others and/or which may take into account other patient-relating timing factors.

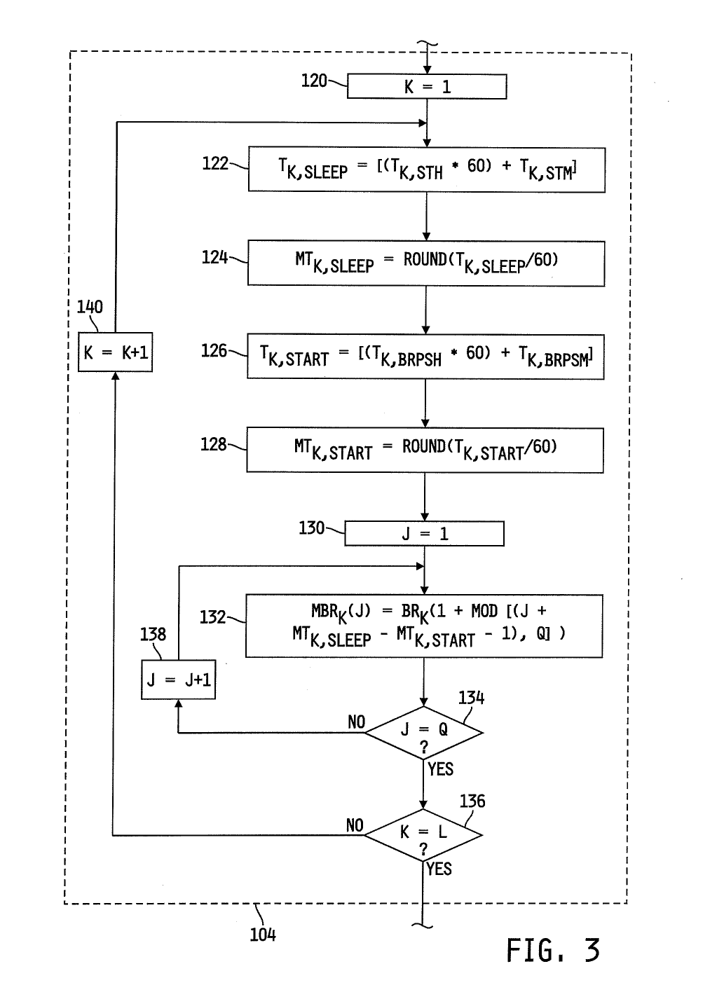

Referring now to FIG. 3, a flowchart is shown of one illustrative embodiment of step 104 of the process illustrated in FIG. 2. In the illustrated embodiment, the process illustrated in FIG. 3 processes all of the patient records (total number of patient records=L) to align the basal rate profiles in each of the plurality of patient records so that the first basal rate in each patient records begins at the patient's normal sleep time. The process begins at step 120 where a counter, K, is set to one. Thereafter at step 122, the Kth patient's normal sleep time, taken from the Kth patient record, is modified to represent the patient's normal sleep time in units of minutes since midnight. Step 122 presumes that the Kth patient's normal sleep time was recorded in the Kth patient record in units of standard military time; e.g., number of hours since midnight followed by the number of minutes elapsed in the current hour. Thus, for example, if the Kth patient's normal sleep time is 10:45 p.m., this would appear in the Kth patient record as 22:45 or 2245. At step 122, the Kth patient's normal sleep time, T_{K,SLEEP}, in units of minutes since midnight, is computed according to the formula:

T_{K,SLEEP}=[(T_{K,STH}*60)+T_{K,STM}] (1),

where T_{K,STH} represents the “hours” portion of the Kth patient's normal sleep time in the Kth patient record and T_{K,STM} represents the “minutes” portion of the Kth patient's normal sleep time in the Kth patient record. Using the same example above, T_{K,SLEEP} for the Kth patient having a normal sleep time of 22:30 would thus be T_{K,SLEEP}=[(22*60)+45]=1365 minutes.

The process illustrated in FIG. 3 advances from step 122 to step 124 where the Kth patient's normal sleep time, T_{K,SLEEP}, that is expressed in units of minutes since midnight is modified in a manner that rounds this normal sleep time to the nearest hour in the 24 hour cycle. Illustratively, this is accomplished at step 124 by computing a modified normal sleep time for the Kth patient according to the formula:

MT_{K,SLEEP}=ROUND(T_{K,SLEEP}/60) (2).

Using the above example, of a normal sleep time for the Kth patient of 1365 minutes since midnight, equation (2) would yield MT_{K,SLEEP}=ROUND(1365/60)=ROUND(22.75)=23, which corresponds to 2300 hours or 11:00 p.m. It will be understood that this disclosure contemplates embodiments wherein a patient's normal sleep time is recorded in that patient's record in a format other than military time, and in such embodiments step 122 and/or 124 of the process illustrated in FIG. 3 will be modified to accommodate any such alternate forms of a patient's recorded normal sleep time. Any such modifications, including omitting step 122 and/or 124, or modifying the mathematical function illustrated in either of steps 122 and 124, would be a mechanical step for someone skilled in the art.

As described above, many, but not all, programmable drug delivery mechanisms define the first of the 24 one-hour intervals of basal rate drug delivery as beginning at midnight. The process illustrated in FIG. 3 further processes the starting times of such drug delivery mechanisms in the patient records to account for potentially different drug delivery mechanism starting times in the plurality of patient records. Illustratively, steps 126 and 128 of the process of FIG. 3 process the starting times of such programmable drug delivery mechanisms in the patient records identically as set forth above for steps 122 and 124 to thereby determine a modified start time, MT_{K,START}, of the programmable drug delivery mechanism, e.g., infusion pump, for the Kth patient relative to a reference starting time, e.g., midnight. At step 126, the Kth patient's drug delivery mechanism start time, T_{K,START}, in units of minutes since midnight, is computed according to the formula:

T_{K,START}=[(T_{K,BRSH}*60)+T_{K,BRSM}] (3),

where T_{K,BRSH} represents the “hours” portion of the drug delivery mechanism starting time for delivering the first basal rate of the drug to the Kth patient, and T_{K,BRSM} represents the “minutes” portion of the drug delivery mechanism starting time for delivering the first basal rate of the drug to the Kth patient. Illustratively, T_{K,BRSH} and T_{K,BRSM} are stored in the Kth patient record in units of standard military time as described above, although this disclosure contemplates storing T_{K,BRSH} and T_{K,BRSM} in the patient records using other formats, and modifying either or both of steps 126 and 128 to accommodate any such other formats, as also described above.

Following step 128, the process illustrated in FIG. 3 advances to step 130 where another counter, J, is set to one. Thereafter at step 132, the timing of the basal rate profile for the Kth patient is modified so that the first basal rate in the Kth patient's record begins at the Kth patient's normal sleep time and the remaining basal rates in the Kth patient's record sequentially follow the first basal rate. This requires processing of each of the plurality, e.g., 24, basal rates for the Kth patient according to the formula:

MBR_{K}(J)=BR_{K}(1+MOD [(J+MT_{K,SLEEP}−MT_{K,START}−1),Q] (4),

where MBR_{K}(J) is the Jth modified basal rate number for the Kth patient, BR_{K}( ) is the corresponding original basal rate number for the Kth patient, Q is the total number of basal rate profiles, e.g., 24, and MOD is the well-known modulo function. Following step 132, the value of J, corresponding to the basal rate number for the Kth patient that is currently being processed, is compared at step 134 to Q, corresponding to the total number of basal rates, e.g., 24. If J is not equal to Q at step 134, the process advances to step 138 where the value of J is incremented by one, and the process then loops from step 138 back to step 132 to process the next basal rate in the Kth patient record. If, at step 134, J=Q, the process advances to step 136 where K, corresponding to the current patient record being processed, is compared with L, corresponding to the total number of patient records. If K is not equal to L at step 136, the process advances to step 140 where the value of K is incremented by one, and the process then loops from step 140 back to step 122. If, at step 136, K=L, the process illustrated in FIG. 3 is complete.

As another numerical example of the process illustrated in FIG. 3 for aligning basal rate profiles in each of the patient records, assume that the Kth patient's normal sleep time is 9:00 p.m., and that the Kth patient uses a programmable infusion pump to deliver the drug, and that the starting time for the programmable infusion pump is midnight (12:00 a.m.). Also assume that the Kth patient's normal sleep time and programmable infusion pump starting time are both stored in the standard military time format so that the patient's normal sleep time is stored in the Kth patient record as 21:00, and the starting time for the Kth patient's programmable infusion pump is stored in the Kth patient record as 00:00. In this example, MT_{K,SLEEP}=21 and MT_{K,START}=0. The first several executions of step 132 then yield MBR_{K}(1)=BR_{K}(22), MBR_{K}(2)=BR_{K}(23), MBR_{K}(3)=BR_{K}(24), MBR_{K}(4)=BR_{K}(1), etc. The basal rate profile for the Kth patient is thus modified so that the first basal rate, i.e., MBR_{K}(1), begins at the patient's normal sleep time, e.g., 9:00 p.m., corresponding to the 22^{nd} basal rate in the original patient record, and the remaining number, e.g., 23, of basal rates that define the basal rate profile for the Kth patient are correspondingly numbered to sequentially follow this first basal rate.

Referring again to FIG. 2, the process 100 advances from step 104 to step 106. Alternatively or additionally, step 106 may represent another entry point “B” for the process 100 of FIG. 2. Entry point B may be used, for example, when it is desirable to work with the data in the existing patient records. In any case, the existing patient records are filtered at step 106 to produce a subset of the collected patient information consisting only of patient records that include a medical condition indicator indicating that a corresponding medical condition of the patient is acceptable. As described hereinabove with respect to step 102, the collected patient information may include medical condition information, and such medical condition information may include one or more indicators of a patient's general or specific health. Examples of such one or more medical condition indicators were provided hereinabove, and include, but should not be limited to, Hb1AC and/or one or more other measures of glycemic control and/or one or more other measures of the efficacy of the current diabetes therapy, average daily, weekly or monthly blood glucose level, or the like. In one illustrative embodiment, for example, each of the plurality of patient records includes an Hb1AC value or other glycemic control indicator that is indicative of an efficacy of a diabetes treatment drug in treating that patient's diabetic condition. In this embodiment, each of the plurality of patient records is processed at step 106 by comparing the glycemic control indicator with a threshold glycemic control indicator value. The threshold glycemic control indicator value is illustratively selected to be a minimum glycemic control indicator value such that glycemic control indicator values greater than the threshold glycemic control indicator value are indicative of acceptable glycemic control. Only those of the plurality of patient records having glycemic indicator values that are greater than the threshold glycemic indicator value at step 106 are included in the subset of the collected information. It will be appreciated that in other embodiments, the threshold glycemic control indicator value may be a maximum glycemic control indicator value, or may include minimum and maximum glycemic control indicator values that define a region of acceptable glycemic control between the minimum and maximum values or may be a linear or non-linear function of the glycemic control indicator and/or one or more other patient specific parameters.

From step 106, the process 100 advances to step 108 where the subset of collected patient information is partitioned into a number, N, of different patient information subgroups each containing only patient records that are identified by different combinations of categorical patient parameters forming part of the patient records, wherein N may be any positive integer greater than 1. As described hereinabove with respect to step 102, the collected patient information may include categorical patient information, i.e., one or more categorical patient parameters, each of which places a patient in one of a number of categories. Illustratively, one or more of the categorical patient parameters may place a patient in either of two categories, and others of the categorical patient parameters may place a patient in one of more than two categories. In any case, the patient records are processed at step 108 to partition the patient records into a number, N, of different patient information subgroups, wherein N is determined by the number, M, of categorical patient parameters used and also by the number of categories defined by each of the categorical patient parameters. As an illustrative example of step 108, assume that M=3 and the categorical patient parameters include patient gender, diabetes type (e.g., 1 or 2) and whether or not the patient experiences the dawn or pre-dawn effect (e.g., yes or no). Each of these categorical patient parameters define two categories (e.g., male or female, type 1 or type 2, and yes or no), and the number of different patient information subgroups formed at step 108 is therefore 2^{M}=2³=8. The eight different patient information subgroups formed at step 108 in this example each include only patient records containing a different combination of the outcome of the three categorical patient parameters, as summarized in Table I below.

TABLE I

| Patient Information | | | |
|---|---|---|---|
| Subgroup | Gender | Diabetes Type | Dawn/Pre-Dawn |
| 1 | F | 1 | Y |
| 2 | F | 1 | N |
| 3 | F | 2 | Y |
| 4 | F | 2 | N |
| 5 | M | 1 | Y |
| 6 | M | 1 | N |
| 7 | M | 2 | Y |
| 8 | M | 2 | N |

Patient information subgroup 1 contains only patient records for females having type 1 diabetes that experience the dawn/pre-dawn phenomenon, patient information subgroup 2 contains only patient records for females having type 1 diabetes that do not experience the dawn/pre-dawn phenomenon, patient information subgroup 3 contains only patient records for females having type 2 diabetes that experience the dawn/pre-dawn phenomenon, and so forth. In cases where one or more of the categorical patient parameters define more that two categories, e.g., such as more than two weight ranges for a categorical patient parameter “weight,” the number, N, of patient information subgroups will accordingly be more than 2^{M}, where M is the number of categorical patient parameters.

Following step 108, the process 100 advances to step 110 where each of the N different patient information subgroups is processed to generate a corresponding plurality of basal rate models. Each of the plurality of basal rate models for each patient information subgroup is configured to model a corresponding one of the plurality of individual basal rates for that patient information subgroup. Using the example set forth in Table I above, a plurality of basal rate models, e.g., 24, are generated at step 110 for each of the eight different patient information subgroups. Each set of basal rate models is determined using the information contained in the patient records for the corresponding patient information subgroup.

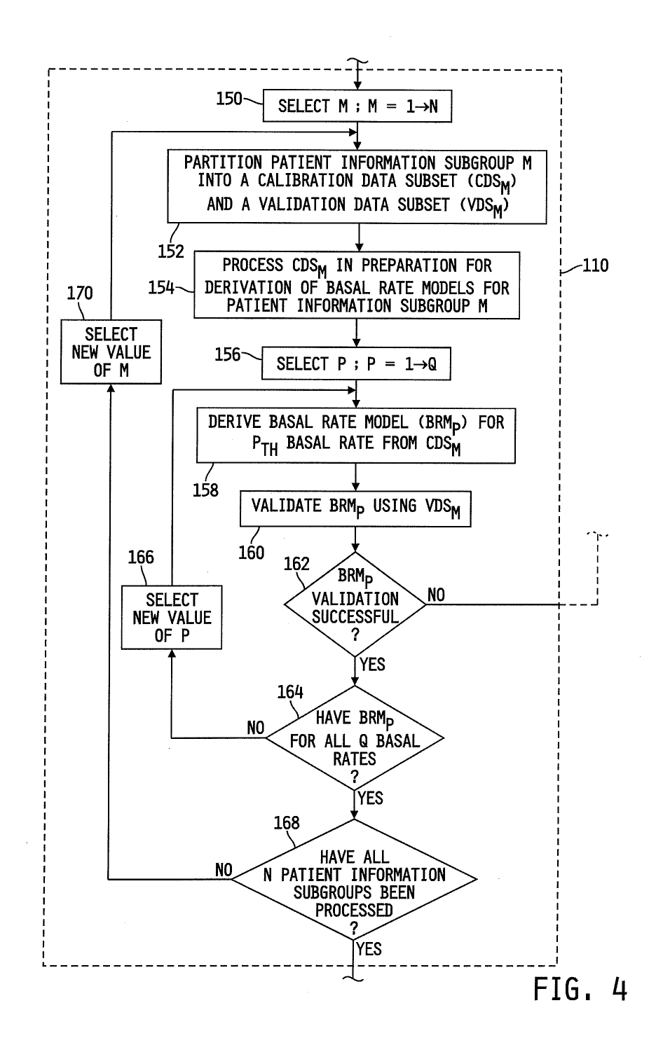

Referring now to FIG. 4, a flowchart is shown of one illustrative process for executing step 110 of the process 100 of FIG. 2 to generate a plurality of basal rate models for each of the N patient information subgroups. In the illustrated embodiment, the process illustrated in FIG. 4 begins at step 150 where the value of a variable, M, is selected. The value of M selected at step 150 may range between 1 and N, wherein N is the total number of patient information subgroups. Illustratively, M may be selected at step 150 to have the value 1, although it will be understood that any value between 1 and N may be selected for M at step 150. In any case, the process illustrated in FIG. 4 advances from step 150 to step 152 where the patient information subgroup M is further partitioned into a calibration data subset (CDS_{M}) and a validation data subset (VDS_{M}). In one illustrative embodiment, the patient information in subset M is partitioned into the calibration and validation data subsets, CDS_{M} and VDS_{M} respectively, by first sorting the patient information in the patient information subgroup M by the independent variables, e.g., age, weight, etc., and then assigning every second record in the sorted set to the calibration data subset, CDS_{M}. The remaining records in the sorted patient information subgroup M are then assigned to the validation data subset, VDS_{M}. It will be understood, however, that the patient information in any subgroup M may alternatively or additionally be partitioned into calibration and validation data subsets, CDS_{M} and VDS_{M} respectively, according to any one or more known data splitting or partitioning techniques.

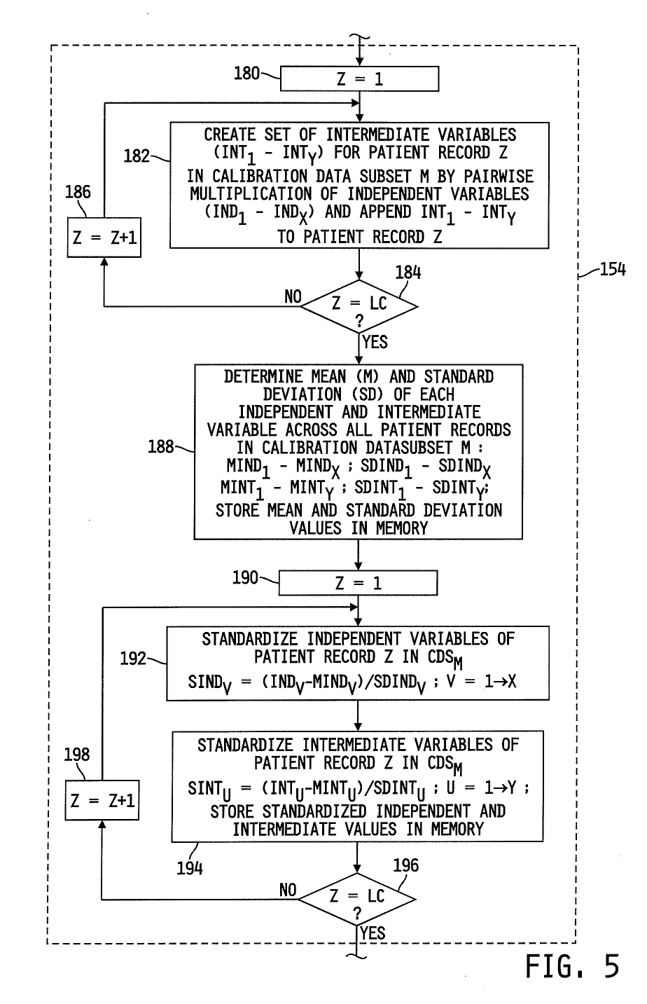

From step 152, the process illustrated in FIG. 4 advances to step 154 where the Mth calibration data subset is processed in preparation for the derivation of the plurality of basal rate models for the patient information subgroup M. Referring now to FIG. 5, one illustrative embodiment of a process for executing step 154 of the process illustrated in FIG. 4 is shown. In the illustrated embodiment, the process illustrated in FIG. 5 begins at step 180 where a count variable, Z, is set to one. Thereafter at step 182, a set of Y intermediate variables, INT₁-INT_{Y}, are created for the patient record Z from the calibration data subset M, where Y may be any integer. Illustratively, each patient record in the Mth calibration data subset has X independent variables, wherein X may be any integer greater than 1. The Y intermediate variables, INT₁-INT_{Y}, for patient record Z of the calibration data subset M are created by pairwise multiplication of the X independent variables, IND₁-IND_{X}, of the Zth patient record, and the resulting intermediate variables, INT₁-INT_{Y} are then appended to the Zth patient record or otherwise stored in memory. Thereafter at step 184, the count value Z is compared to a stored count value, LC, where LC is the record length of the Mth calibration data set, i.e., the total number of patient records in the Mth calibration data subset. If, at step 184, Z is not yet equal to LC, the count value Z is incremented by one at step 186 and execution of the process illustrated in FIG. 5 then loops back to step 182. If Z=LC at step 184, execution of the process illustrated in FIG. 5 advances to step 188.

At step 188, the mean (M) and standard deviation (SD) of each independent and intermediate variable in each patient record of the Mth calibration data subset, CDS_{M}, are determined using conventional techniques. Thus, in the example given above in which each patient record in the Mth calibration data subset, CDS_{M}, has X independent variables and Y intermediate variables, the mean values of the independent variables are represented as MIND₁-MIND_{X}. the standard deviation values of the independent variables are represented as SDIND₁-SDIND_{X}, the mean values of the intermediate variables are represented as MINT₁-MINT_{Y} and the standard deviation values of the intermediate variables are represented as SDINT₁-SDINT_{Y}. Each of the mean and standard deviation values are stored in memory Illustratively, the mean and standard deviation values may be appended to corresponding patient information records.

Following step 188, the counter value Z is again set to one at step 190. Thereafter at step 192, each of the independent variables of the Zth patient record of the Mth calibration data subset, CDS_{M}, is standardized with respect to its mean and standard deviation values. Illustratively, each of the independent variables of the Zth patient record of the Mth calibration data subset, CDS_{M}, is standardized at step 192 using the formula SIND_{V}=(IND_{V}-MIND_{V})/SDIND_{V}, where V ranges from 1 to X and where SIND_{V} is the Vth standardized independent variable of the Zth patient record of the Mth calibration data subset, CDS_{M}. Alternatively or additionally, each of the independent variables of the Zth patient record of the Mth calibration data subset, CDS_{M}, may be standardized at step 192 using one more other conventional data standardization techniques.

Following step 192, each of the intermediate variables of the Zth patient record of the Mth calibration data subset, CDS_{M}, is standardized with respect to its mean and standard deviation values. Illustratively, each of the intermediate variables of the Zth patient record of the Mth calibration data subset, CDS_{M}, is standardized at step 194 using the formula SINT_{U}=(INT_{U}-MINT_{U})/SDINT_{U}, where U ranges from 1 to Y and where SINT_{U} is the Uth standardized intermediate variable of the Zth patient record of the Mth calibration data subset, CDS_{M}. Alternatively or additionally, each of the intermediate variables of the Zth patient record of the Mth calibration data subset, CDS_{M}, may be standardized at step 194 using one more other conventional data standardization techniques. In any case each of the standardized independent variables, SIND_{V}, and the standardized intermediate variables, SINT_{U}, are stored in memory. Illustratively, the standardized independent variables, SIND_{V}, and the standardized intermediate variables, SINT_{U}, may be appended to corresponding patient information records.

Following step 194, the count value Z is compared to LC at step 196, where LC is the record length of the Mth calibration data set, i.e., the total number of patient records in the Mth calibration data subset. If, at step 196, Z is not yet equal to LC, the count value Z is incremented by one at step 198 and execution of the process illustrated in FIG. 5 then loops back to step 192. If Z=LC at step 196, execution of the process illustrated in FIG. 5 returns to the process of FIG. 4.

It should be apparent that the process illustrated in FIG. 5 operates to process each of the patient records in the Mth calibration data subset to create a plurality of additional, intermediate variables, INT₁-INT_{Y}, from the existing independent variables, IND₁-INT_{X}, and to then append the newly created intermediate variables, INT₁-INT_{Y}, to the corresponding patient record in the Mth calibration data subset, to compute the means and standard deviations of all of the independent and intermediate variables in each record of the Mth calibration data subset, and to then standardized all of the independent and intermediate variables in each record of the Mth calibration data subset.

Referring again to FIG. 4, the illustrated process advances from step 154 to step 156 where the value of another variable, P, is selected. The value of P selected at step 156 may range between 1 and Q, where Q is the total number of basal rates for which basal rate models will be developed. In the examples provided above, basal rates are defined in one-hour increments over a 24-hour cycle, and in such cases Q=24. It will be understood, however, that more or fewer basal rates may be defined over a 24-hour time period or over a time period that is greater or less than 24 hours. The value of P may illustratively be selected at step 156 to have the value 1, although it will be understood that any value between 1 and Q may be selected for P at step 156. In any case, the process illustrated in FIG. 4 advances from step 156 to step 158 where the Pth basal rate model, BRMₚ, for the Mth calibration data subset, i.e., the calibration data subset for the Mth patient information subgroup, is derived from the patient information contained in the Mth calibration data subset (and also from information stored elsewhere in cases where mean, standard deviation and/or standardized variables are not appended to the patient records contained in the calibration data subset, CDS_{M}.

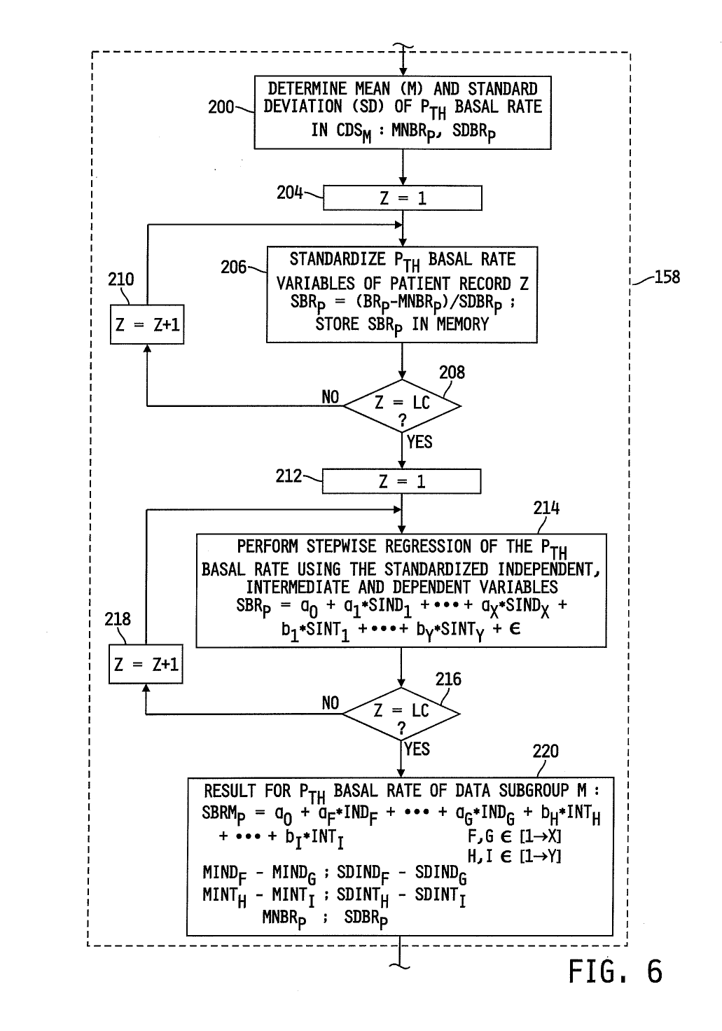

Referring now to FIG. 6, one illustrative embodiment of a process for executing step 158 of the process illustrated in FIG. 4 is shown. In the illustrated embodiment, the process illustrated in FIG. 6 begins at step 200 where the mean and standard deviation of the Pth basal rate amongst all patient records in the Mth calibration data subset, CDS_{M}, are determined. The mean Pth basal rate, MNBR_{P}, and the standard deviation of the Pth basal rate, SDBR_{P}, are computed using the Pth basal rate in each of the patient records contained in the Mth calibration data subset, CDS_{M}, using conventional techniques. Thereafter at step 204, a count variable, Z, is set to one. Thereafter at step 206, the Pth basal rate value in the Zth patient record of the Mth calibration data subset, CDS_{M}, is standardized with respect to its mean and standard deviation values. Illustratively, the Pth basal rate value in the Zth patient record of the Mth calibration data subset, CDS_{M}, is standardized at step 206 using the formula SBR_{P}=(BR_{P}-MNBR_{P})/SDBR_{P}, where SBR_{P} is the Pth standardized basal rate value of the Zth patient record of the Mth calibration data subset, CDS_{M}. Alternatively or additionally, the Pth basal rate in the Zth patient record of the Mth calibration data subset, CDS_{M}, may be standardized at step 206 using one more other conventional data standardization techniques. In any case the Pth standardized basal rate value, SBR_{P} for the Zth patient record of the Mth calibration data subset, CDS_{M}, is store in memory. Illustratively, the Pth standardized basal rate value, SBR_{P}, may be appended to the Zth patient information record.

Following step 206, the count value Z is compared to LC at step 208, where LC is the record length of the Mth calibration data set, i.e., the total number of patient records in the Mth calibration data subset. If, at step 208, Z is not yet equal to LC, the count value Z is incremented by one at step 210 and execution of the process illustrated in FIG. 6 then loops back to step 206. If Z=LC at step 208, execution of the process illustrated in FIG. 6 advances to step 212 where the counter value, Z, is again set to one. Thereafter at step 214, a convention statistical technique, e.g., a conventional regression technique, is used to create a model of the Pth basal rate of the Mth calibration data set, CDS_{M}, based on the standardized independent, intermediate and dependent variables. While other conventional regression techniques may be used, a conventional stepwise regression technique is used in one embodiment of step 214 to derive the model of the Pth basal rate of the Mth calibration data set, CDS_{M}, according to the equation:

SBR_{P}=a₀+a₁*SIND₁+ . . . +a_{X}*SINT_{X}+b₁*SINT₁+ . . . +b_{Y}*SINT_{Y}+ε (5),

where SBR_{P} is the Pth standardized basal rate, SIND₁-SINT_{X} are the standardized independent variables, SINT₁-SINT_{Y} are the standardized intermediate variables, a₀-a_{X} and b₁-b_{Y} are the model coefficients determined by the regression technique, and ε is a conventional error term. Following step 214 the count value Z is compared to LC at step 216, where LC is the record length of the Mth calibration data set. If, at step 216, Z is not yet equal to LC, the count value Z is incremented by one at step 218 and execution of the process illustrated in FIG. 6 then loops back to step 214. If Z=LC at step 216, execution of the process illustrated in FIG. 6 advances to step 220 where the result of the process illustrated in FIG. 6 is a basal rate model for the Pth basal rate of the Mth calibration data subset, CDS_{M}. By using a stepwise regression technique at step 214, only variables that contribute significantly to the model will remain in the model. The significance level can be chosen to influence the actual model selection. What remains at step 220 of the process illustrated in FIG. 6, is thus the Pth basal rate model for the Pth basal rate of the Mth calibration data subset, CDS_{M}, as well as the mean, standard deviation and standardized variable values that were computed and stored along the way to computing creating the model. The model for the Pth basal rate of the Mth calibration data subset, CDS_{M}, at step 220 of FIG. 6 reflects that not all of the independent and/or intermediate variables will be retained by the model, and is therefore represented by the formula:

SBRM_{P}=a₀+a_{F}*SIND₁+ . . . +a_{G}*SIND_{G}+b_{H}*SINT_{H}+ . . . +b_{I}*SINT_{I}+ε (6),

where F and G are elements of the set [1, X], and H and I are elements of the set [1, Y]. The corresponding mean values of the independent and intermediate variables, MIND_{F}-MIND_{H} and MINT_{H}-MINT_{I}, the corresponding standard deviation values of the independent and intermediate variables, SDIND_{F}-SDIND_{G} and SDINT_{H}-SDINT_{I}, the mean value of the Pth basal rate, MNBR_{P} and the standard deviation of the Pth basal rate, SDBR_{P}, are also shown in step 220. The mean and standard deviation values will be used to compute a modified intercept value when the Pth basal rate model is subsequently validated since the variables in the Mth validation data set, VDS_{M}, are per se not standardized. In any case, from step 220, the process of FIG. 6 returns to step 158 of the process of FIG. 4.

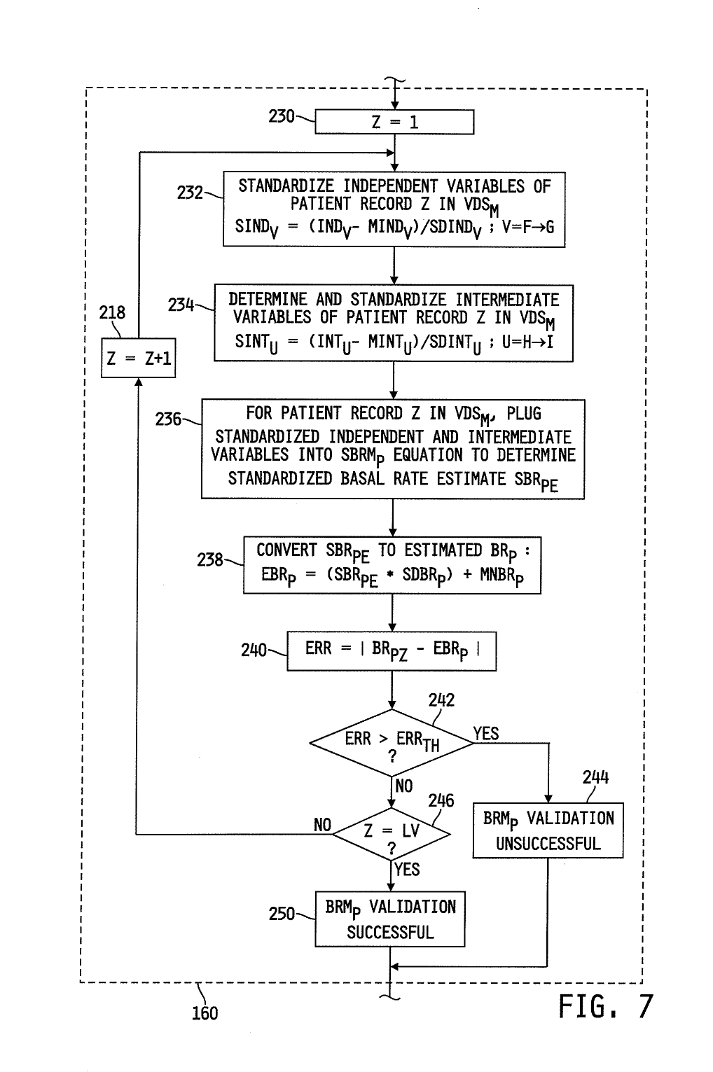

Referring again to FIG. 4, the illustrated process advances from step 158 to step 160 where the Pth basal rate model, SBRM_{P}, for the Mth calibration data subset, CDS_{M}, is processes using the validation data subset, VDS_{M}, to determine whether the Pth basal rate model, SBRM_{P}, is valid. Referring now to FIG. 7, one illustrative embodiment of a process for executing step 154 of the process illustrated in FIG. 4 is shown. In the illustrated embodiment, the process illustrated in FIG. 7 begins at step 230 where a count variable, Z, is set to one. Thereafter at step 232, the independent variables in the Zth patient record of the Mth validation data subset, VDS_{M}, that correspond to the independent variables remaining in the Pth basal rate model, i.e., independent variables F-G (e.g., see step 220 of FIG. 6), are standardized to the mean and standard deviation values of the corresponding independent variables from the calibration data subset, CDS_{M}. Illustratively, these independent variables in the Zth patient information record of the Mth validation data subset, VDS_{M}, are standardized according to the formula SIND_{V}=(IND_{V}-MIND_{V})/SDIND_{V}, where V ranges from F to G consistently with step 220 of FIG. 6, and where SIND_{V} is the Vth standardized independent variable of the Zth patient record of the Mth validation data subset, VDS_{M}. Alternatively or additionally, the noted independent variables of the Zth patient record of the Mth validation data subset, VDS_{M}, may be standardized at step 232 using one more other conventional data standardization techniques.

Following step 232, the intermediate variables in the Zth patient record of the Mth validation data subset, VDS_{M}, that correspond to the intermediate variables remaining in the Pth basal rate model, i.e., independent variables H-I (e.g., see step 220 of FIG. 6), are determined and then standardized to the mean and standard deviation values of the corresponding intermediate variables from the calibration data subset, CDS_{M}. Illustratively, each of these intermediate variables, INT_{H}-INT_{I}, of the Zth patient record of the Mth validation data subset, VDS_{M}, is determined as described hereinabove with respect to step 182 of the process of FIG. 5, and then each is standardized at step 234 using the formula SINT_{U}=(INT_{U}-MINT_{U})/SDINT_{U}, where U ranges from H-I and where SINT_{U} is the Uth standardized intermediate variable of the Zth patient record of the Mth validation data subset, VDS_{M}. Alternatively or additionally, each of the intermediate variables of the Zth patient record of the Mth validation data subset, VDS_{M}, may be standardized at step 234 using one more other conventional data standardization techniques. In any case each of the standardized independent variables, SIND_{V}, and the standardized intermediate variables, SINT_{U}, of the validation data subset, VDS_{M}, are stored in memory. Illustratively, the standardized independent variables, SIND_{V}, and the standardized intermediate variables, SINT_{U}, of the Mth validation data subset, VDS_{M}, may be appended to corresponding patient information records.

Following step 234, the standardized independent and intermediate variables for the Zth record in the Mth validation data subset, VDS_{M}, are plugged into equation (6) above, corresponding to the Pth basal rate model, at step 236 to compute a standardized basal rate estimate, SBRM_{PE}. Thereafter at step 238, the standardized basal rate estimate, SBRM_{PE}, is converted to a non-standardized basal rate estimate, EBR_{P}. In embodiments in which the formula of step 206 (in the process of FIG. 6) was used to compute the standardized basal rate value, the non-standardized basal rate estimate is computed at step 238 according to the equation EBR_{P}=(SBRM_{PE}*SDBR_{P})+MNBR_{P}, where MNBR_{P} and SDBR_{P} are the mean and standard deviations respectively of the Pth basal rate values over all of the patient information records in the calibration data subset, CDS_{M}. From step 238, the illustrated process advances to step 240 where an error value, ERR, is computed as an absolute value of the difference between the Pth basal rate of the Zth patient information record, BR_{PZ}, of the Mth validation data subset, VDS_{M}, and the estimated value of the Pth basal rate using the model of the Pth basal rate that was created in the process of FIG. 6. Thereafter at steps 242-250, the error value, ERR, is evaluated to determine whether the validation process is successful.

At step 242, the error value, ERR, is compared with an error threshold, ERR_{TH}, which has been pre-selected to achieve a desired level of model certainty, and which is stored in memory. If, at step 242, the error value, ERR, exceeds the threshold error value, ERR_{TH}, the illustrated process advances to step 244 where the message BRM_{P} VALIDATION UNSUCCESSFUL is generated to indicate that validation of the Pth basal rate model has failed. Thereafter, the illustrated process is returned to step 160 of the process illustrated in FIG. 4. If, at step 242, the error value, ERR, does not exceed the threshold error value, ERR_{TH}, the illustrated process advances to step 246 where the count value, Z, is compared with a value LV that corresponds to the record length of the Mth validation data subset, VDS_{M}, i.e., LV is equal to the number of patient information records in the Mth validation data subset, VDS_{M}. If, at step 246, Z is not yet equal to LV, the count value, Z, is incremented by one at step 248 and the illustrated process loops back to step 232 to process another patient information record in the Mth validation data subset, VDS_{M}. If, at step 246, Z is equal to LV, the illustrated process advances to step 250 where the message BRM_{P} VALIDATION SUCCESSFUL is generated to indicate that validation of the Pth basal rate model generated by the process illustrated in FIG. 6 using each of the patient information records in the Mth validation data subset, VDS_{M}, was successful. Following step 250, the illustrated process is returned to step 160 of the process illustrated in FIG. 4.

Referring again to FIG. 4, the illustrated process advances from step 160 to step 162 where the message generated by the process of FIG. 7 is evaluated to determine whether validation of the Pth basal rate model was successful. If not, the illustrated process returns to FIG. 2. If, however, it is determined at step 162 that validation of the Pth basal rate model was successful, the illustrated process advances to step 164 where a determination is made as to whether basal rate models have been created and validated for all of the Q basal rates. If not, the illustrated process advances to step 166 where a new value of P, between 1 and Q, is selected, and the process then loops back to step 158 to create and validate another basal rate model. If, at step 164, it is determined that basal rate models have been created for all of the Q basal rates for the Mth patient information subgroup, the illustrated process advances to step 168 where a determination is made as to whether all of the N patient information subgroups have been process. If not, the illustrated process advances to step 170 where a new value of M, between 1 and N, is selected, and the process then loops back to step 152 to process another of the N patient information subgroups. If, at step 168, it is determined that all of the N patient information subgroups have been processed, the process illustrated in FIG. 4 returns to step 110 of the process 100 of FIG. 2.

Referring again to FIG. 2, step 110 is further configured to act upon whether the process of FIG. 4 aborted and returned to step 110 because at least one of the basal rate models could not be validated. If this occurs, the process 100 loops back, via the dashed line illustrated in FIG. 2, in one embodiment to step 102 so that additional patient data can be collected before executing steps 104-110 again. Alternatively, the process 100 may loop back, via the dashed line illustrated in FIG. 2, to step 106 so that the filtering process of step 106 may be re-executed using a revised definition of an acceptable medical condition. Those skilled in the art will recognize one or more other processes that may be undertaken in the event that at least one of the basal rate models cannot be validated, and any such one or more other processes are contemplated by this disclosure.

If at step 110, it is determined that all of the created basal rate models were validated, the process 100 advances to step 112 where the plurality of basal rate models for each of the N patient information subgroups, along with basal rate mean and standard deviation values, are stored in memory. Thereafter, the process 100 ends.

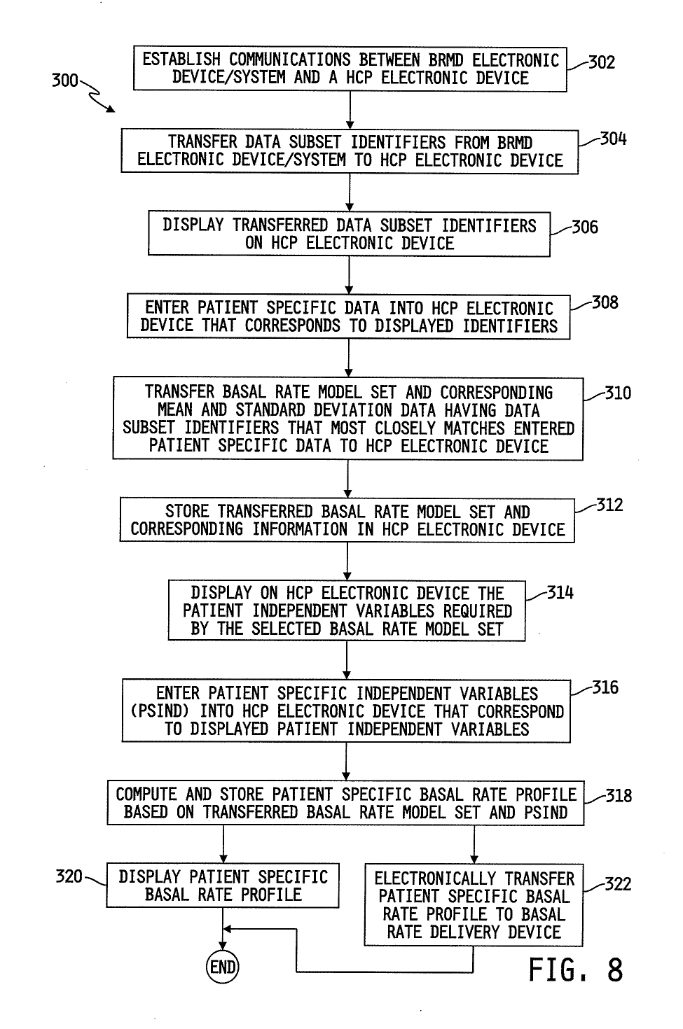

Referring now to FIG. 8, a flowchart is shown of one illustrative embodiment of a process 300 for developing diabetes therapy for a patient consisting of a patient-specific basal rate profile. The patient-specific basal rate profile is determined in accordance with the process 300 by selecting one of a plurality of sets of basal rate models, and then applying information that is specific to the patient to the selected set of basal rate models to generate a corresponding set of basal rates that define delivery of a diabetes therapy drug to the patient over a period of time. The corresponding set of basal rates of the diabetes therapy drug may then be delivered to the patient over successive periods of time using any conventional drug delivery mechanism or technique.

Illustratively, the process 300 may be carried out by a health care professional using one of the HCP electronic devices 40₁-40_{M}, although this disclosure contemplates that the process 300 may alternatively be carried out by other persons and/or using one or more other electronic devices. The plurality of sets of basal rate models may be or include any of the one or more sets of basal rate models generated as described herein, although this disclosure contemplates that the process 300 may alternatively determine the set of patient-specific basal rates using other basal rate model sets. In either case, the plurality of basal rate model sets are stored in the BRMD electronic device/system 12 or in any of the electronic devices/systems 30₁-30_{N}, and are accessible by the HCP electronic device 40₁-40_{M} or other electronic device/system using any of the data transfer structures and/or techniques described hereinabove with respect to FIG. 1. For purposes of describing the operation of the process 300, the plurality of basal rate model sets will be described as being stored in the database 16 of the BRMD electronic device/system 12 and the process 300 will be described as being carried out on the HCP electronic device 40₁, although it will be understood that this particular arrangement is provided only by way of example and should not be considered to be limiting in any way. Illustratively, the process 300 is provided in the form of instructions, e.g., one or more software algorithms, that are stored in the memory 46 and that are executable by the processor 42 to carry out, at least in part, the process 300. Alternatively, one or more steps of the process 300 may be carried out by the BRMD electronic device/system 12 or other suitable electronic device, and such one or more steps of the process 300 will generally be provided in the form of instructions that are stored in the database 16, memory 18 or other suitable memory and that are executable by the processor 14 or other suitable processor.

The process 300 begins at step 302 where communications is established between the BRMD electronic device/system 12 and the HCP electronic device 40₁. Illustratively, the HCP electronic device 40₁ is operable to initiate the communications with the BRMD electronic device/system 12, although this disclosure contemplates alternate embodiments in which the BRMD electronic device/system 12 is operable at step 302 to establish communications with the HCP electronic device 40₁. In any case, communications between the BRMD electronic device/system 12 and the HCP electronic device 40₁ may be established via any communication medium illustrated and described hereinabove with respect to FIG. 1.

The process 300 advances from step 302 to step 304 where a plurality of data subset identifiers are transferred from the BRMD electronic device/system 12 to the HCP electronic device 40₁, and thereafter at step 306 the plurality of data subset identifiers are displayed on the HCP electronic device 40₁. Illustratively, the HCP electronic device 40₁ is operable at step 304 to request transmission of the data subset identifiers from the BRMD electronic device/system 12, although this disclosure contemplates alternate embodiments in which the BRMD electronic device/system 12 is operable at step 304 to transfer unprompted the data subset identifiers after communications with the HCP electronic device 40₁ is established. In any case, the plurality of data subset identifiers transferred to, and displayed on, the HCP electronic device 40₁ at steps 304 and 306 correspond to identifiers of the categorical patient parameters that were used to partition the subset of the collected patient information into the N different patient information subgroups at step 108 of the process 100 of FIG. 2. Using the example of Table I above, the categorical patient parameters used to partition the subset of the collected patient information into the eight different patient information subgroups were patient gender (M or F), diabetes type (type 1 or type 2) and whether or not the patient experiences the dawn or pre-dawn effect (yes or no). In this example, the data subset identifiers transferred to, and displayed on, the HCP electronic device 40₁ would thus be patient gender, diabetes type and dawn/pre-dawn effect. In embodiments that use more, fewer and/or other categorical patient parameters to partition the subset of the collected patient information into the N different patient information subgroups, the data subset identifiers transferred to, and displayed on, the HCP electronic device 40₁ will be accordingly modified. In embodiments in which one or more of the categorical patient parameters has more than two outcomes, the corresponding one or more data subset identifiers that are transferred to, and that are displayed on, the HCP electronic device 40₁ at steps 304 and 306 may or may not include range or multiple categorical information, e.g., age range, diabetes types in addition to types 1 and 2, etc. In any case, the HCP electronic device 40₁ is operable at step 306 to display the data subset identifiers via the display 44 or other suitable visual and/or audible display device.

The process 300 advances from step 306 to step 308 where the health care professional enters, e.g., via the keypad 48, patient-specific data that correspond to the displayed data subset identifiers, i.e., values of the displayed data subset identifiers that are specific to the patient for whom diabetes treatment is currently being designed, into the HCP electronic device 40₁. The HCP electronic device 40₁ then transfers the entered patient-specific values of the displayed data subset identifiers to the BRMD electronic device/system 12, e.g., in response to a user prompt to do so. Thereafter at step 310, the BRMD electronic device/system 12 transfers the basal rate model set and corresponding mean and standard deviation data (e.g., see step 220 of the process of FIG. 6) that were based on a combination of patient categorical information that most closely matches the patient-specific values of the displayed data subset identifiers that were entered into the HCP electronic device 40₁ at step 308. Thereafter at step 312, the transferred basal rate model set and corresponding mean and standard deviation data are stored in the memory 46 of the HCP electronic device 40₁.

As an example of steps 304-312 of the process 300 that is consistent with Table I above, assume that the patient for whom the diabetes treatment is being designed is a male that has type 2 diabetes and that does experience the dawn/pre-dawn effect. At step 304, the BRMD electronic device/system 12 transfers the data identifiers Patient Gender, Diabetes Type and Dawn/Pre-dawn Effect to the HCP electronic device 40₁, and at step 308 the health care professional enters “male” for Patient Gender, “2” for Diabetes Type and “yes” for Dawn/Pre-dawn Effect. At step 310, the BRMD electronic device/system 12 matches the entered patient-specific values of male, 2 and yes to patient information subgroup 7, and then transfers the basal rate model set and mean and standard deviation data that corresponds to the patient information subgroup 7 to the HCP electronic device 40₁ where the model set and corresponding mean and standard deviation data are stored in the memory 46.

The process 300 advances from step 312 to step 314 where the HCP electronic device 40₁ is controlled to display the independent patient variables required by the basal rate model set that was provided to the HCP electronic device 40₁ at step 310. Illustratively, the HCP electronic device 40₁ is operable at step 314 to process each term in the transferred basal rate model set to determine the independent patient variables that are required by the model set. Alternatively, the basal rate model set that is transferred to the HCP electronic device 40₁ by the BRMD electronic device/system 12 at step 310 may be accompanied by a list of such independent patient variables, in which case the HCP electronic device 40₁ is operable to execute step 314 by reading the independent patient variables from the list provided by the BRMD electronic device/system 12. In any case, the HCP electronic device 40₁ is operable at step 314 to display the independent patient variables via the display 44 or other suitable visual and/or audible display device.

The process 300 advances from step 314 to step 316 where the health care professional enters into the HCP electronic device 40₁ e.g., via the keypad 48, patient-specific values of the displayed independent patient variables (PSIND), i.e., values of the displayed independent patient variables that are specific to the patient for whom diabetes treatment is currently being designed. Thereafter at step 318, the HCP electronic device 40₁ computes and stores in the memory 46 a patient-specific basal rate profile based on the basal rate model set that was transferred to the HCP electronic device 40₁ at step 310 and further based on the patient-specific independent variables, PSIND, that were entered into the HCP electronic device 40₁ at step 316. The patient-specific basal rate profile computed at step 318 consists of a plurality of basal rates of a diabetes treatment drug to be sequentially delivered to the patient over a period of time, e.g., 24 one-hour duration basal rates to be sequentially delivered to the patient during every 24-hour cycle. When the patient-specific basal rate profile is computed at step 318, it is thereafter displayed at step 320, e.g., via the display 44 or other suitable visual and/or audible display device. The health care professional and/or patient may then manually program an automatic diabetes treatment drug delivery device to deliver the diabetes treatment drug to the patient according to the patient-specific basal rate profile, or the health care professional may otherwise instruct the patient to self-administer the diabetes treatment drug according to the patient-specific basal rate profile via an alternate drug delivery device or technique. Alternatively or additionally, the HCP electronic device 40₁ and/or the programmable medication delivery device 60 (see FIG. 1) may be configured at step 322 to electronically transfer the patient-specific basal rate profile from the HCP electronic device 40₁ to the programmable medication delivery device 60. The programmable medication delivery device 60 is then subsequently operable to automatically deliver the diabetes treatment drug to the patient according to the programmed, patient-specific basal rate profile. From either of steps 320 or 322, execution of the process 300 ends.

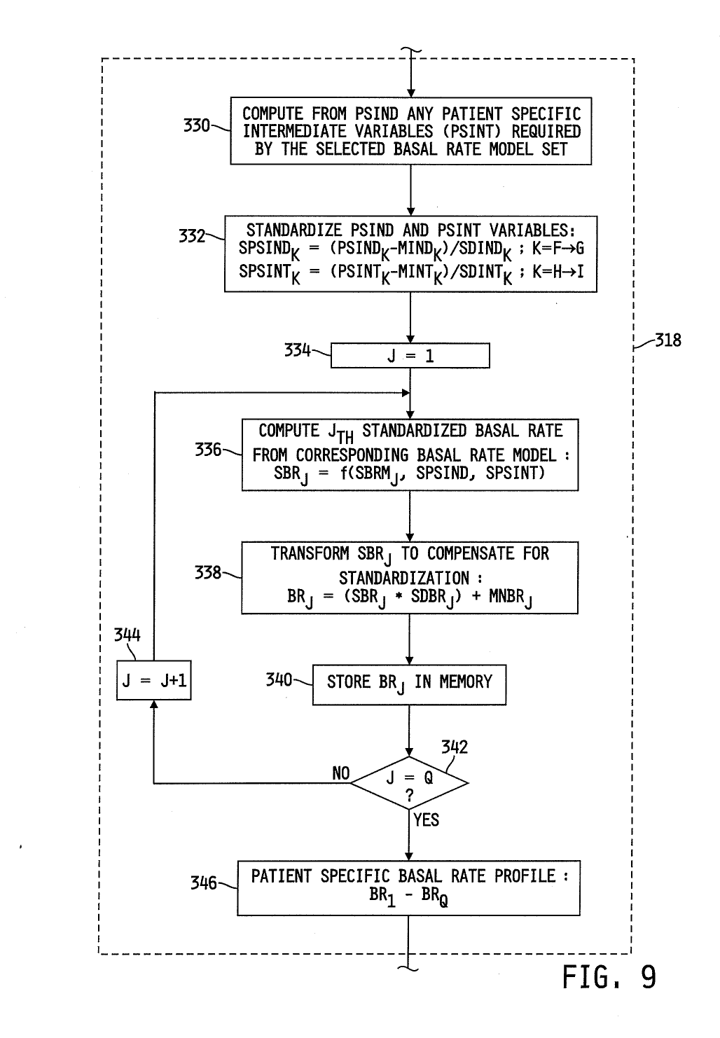

Referring now to FIG. 9, a flowchart is shown of one illustrative process for carrying out step 318 of the process 300 of FIG. 8. In the illustrated embodiment, the process illustrated in FIG. 9 begins at step 330 where any patient-specific intermediate variables, PSINT, that are required by the basal rate model set that was transferred to the HCP electronic device 40₁ at step 310 of the process 300 are computed based on the patient-specific independent variables, PSIND, that were entered into the HCP electronic device 40₁ at step 316 of the process 300. Illustratively, the HCP electronic device 40₁ is operable at step 330 to process each term in the transferred basal rate model set to determine from the independent patient variables the intermediate patient variables that are required by the model set. Alternatively, the basal rate model set that is transferred to the HCP electronic device 40₁ by the BRMD electronic device/system 12 at step 310 of the process 300 may be accompanied by a list of such intermediate patient variables, in which case the HCP electronic device 40₁ is operable at step 330 to determine the required intermediate patient variables by reading the intermediate patient variables from the list provided by the BRMD electronic device/system 12. In any case, the HCP electronic device 40₁ is further operable at step 330 to compute patient-specific values, PSINT, of the intermediate patient variables that are required by the basal rate model set based on the values of the patient-specific independent variables, PSIND, that were entered at step 316 of the process 300.

Following step 330, the patient-specific independent and intermediate variable values, PSIND and PSINT, are standardized at step 332 to the mean and standard deviation values of the corresponding independent and intermediate variables that accompanied the basal rate model set, e.g., see step 220 of FIG. 6. Illustratively, the patient-specific independent variables are standardized according to the formula SPSIND_{K}=(PSIND_{K}−MIND_{K})/SDIND_{K}, where K ranges from F to G consistently with step 220 of FIG. 6, PSIND_{K} is the Kth patient-specific independent variable, MIND_{K} and SDIND_{K} are the mean and standard deviation values for the independent patient variables that were transferred to the HCP electronic device 40₁ at step 310 along with the basal rate model set, and SPSIND_{K} is the Kth standardized patient-specific independent variable. Further illustratively, the patient-specific intermediate variables are standardized according to the formula SPSINT_{K}=(PSINT_{K}−MINT_{K})/SDINT_{K}, where K ranges from H to I consistently with step 220 of FIG. 6, PSINT_{K} is the Kth patient-specific intermediate variable, MINT_{K} and SDINT_{K} are the mean and standard deviation values for the intermediate patient variables that were transferred to the HCP electronic device 40₁ at step 310 along with the basal rate model set, and SPSINT_{K} is the Kth standardized patient-specific intermediate variable. Alternatively or additionally, each of the patient-specific independent and intermediate variables may be standardized at step 332 using one more other conventional data standardization techniques.

Following step 332, a counter value, J, is set equal to one at step 334. Thereafter at step 336, the Jth standardized basal rate value is computed from the corresponding Jth basal rate model, SBRM_{J}, forming part of the basal rate model set that was transferred to the HCP electronic device 40₁ at step 310 of the process 300, as a function of the standardized patient-specific independent and intermediate variables, SPSIND and SPSINT. More specifically, the standardized patient-specific independent and intermediate variables, SPSIND and SPSINT, are plugged into equation (6) above at step 336 to produce the Jth standardized basal rate, SBR_{J}, where the model coefficients a₀, a_{F}-a_{G} and b_{H}-b_{I} are provided by the Jth basal rate model.

Following step 336, the standardized basal rate value, SBR_{J}, is converted or transformed to a non-standardized basal rate value, BR_{J}. Illustratively, the non-standardized basal rate estimate is computed at step 338 according to the equation BR_{J}=(SBR_{J}*SDBR_{J})+MNBR_{J}, where MNBR_{J} and SDBR_{J} are the mean and standard deviations respectively of the Jth basal rate values that accompanied the basal rate model set that was transferred to the HCP electronic device 40₁ at step 310 of the process 300. From step 338, the illustrated process advances to step 340 where the Jth non-standardized basal rate value, BR_{J} is stored in the memory 46. Thereafter at step 342, the counter value, J, is compared to the total number, Q, of basal rates that comprise the basal rate profile. If, at step 342, J does not yet equal Q, the count value, J, is incremented by one at step 344 and the illustrated process then loops back to step 336 to compute another basal rate value. If, at step 342, J=Q, the illustrated process advances to step 346 where the illustrated process is returned to the process 300 of FIG. 8 with the patient-specific basal rate profile comprising Q sequential basal rates, BR₁-BR_{Q}.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

What is claimed is:

1. A method of generating a plurality of basal rate models that together model delivery of a corresponding plurality of basal rates of a diabetes treatment drug to a patient over a period of time, the method comprising:
collecting information from a plurality of patients that have a diabetic condition and to which the diabetes treatment drug has been delivered, the collected information including a glycemic control indicator for each of the plurality of patients that is indicative of an efficacy of the diabetes treatment drug in treating the patient's diabetic condition,
filtering the collected information based on the glycemic control indicators to produce a subset of the collected information that includes information only for patients that exhibit acceptable glycemic control,
generating the plurality of basal rate models based on the subset of the collected information, and
storing the generated plurality of basal rate models in a memory unit.

2. The method of claim 1 wherein the collected information includes values of the basal rates of the diabetes treatment drug delivered to each of the plurality of patients over the period of time,
and wherein generating the plurality of basal rate models comprises generating the plurality of basal rate models based, at least in part, on the values of the plurality of basal rates of the diabetes treatment drug delivered to each of the plurality of patients in the subset of the collected information.

3. The method of claim 1 wherein the collected information includes a plurality of categorical patient parameters for each of the plurality of patients, each of the plurality of categorical patient parameters for each of the plurality of patients having one of two or more possible values or ranges,
and wherein the method further comprises partitioning the subset of the collected information into a number of different patient information subgroups each identified by a different combination of the two or more possible values or ranges of at least two of the plurality of categorical patient parameters,
and wherein generating the plurality of basal rate models comprises generating the plurality of basal rate models based on at least one of the number of different patient information subgroups.

4. The method of claim 3 further comprising:
generating a number of sets of basal rate models, each of the number of sets of basal rate models comprising a plurality of basal rate models that are generated based on a different one of the number of different patient information subgroups, and
storing each of the generated number of sets of basal rate models in the memory unit.

5. The method of claim 1 wherein the collected information comprises a plurality of patient records each for a different one of the plurality of patients, each of the plurality of patient records including a reference time within the period of time and a basal rate profile defining a plurality of basal rates of the diabetes treatment drug sequentially delivered to the corresponding patient over the period of time beginning with a first basal rate and ending with a last basal rate,
and wherein the method further comprises aligning the basal rate profiles in the plurality of patient records as functions of the reference times such that in each of the plurality of patient records the first basal rate of the corresponding basal rate profile begins at the corresponding reference time,
and wherein filtering the collected information comprises filtering the collected information after aligning the basal rate profiles in the plurality of patient records.

6. A method of generating a plurality of basal rate models that together model delivery of a corresponding plurality of basal rates of a diabetes treatment drug to a patient over a period of time, the method comprising:
collecting information from a plurality of patients to which the diabetes treatment drug has been delivered, the collected patient information including a plurality of categorical patient parameters for each of the plurality of patients, each of the plurality of categorical patient parameters for each of the plurality of patients having one of two or more possible values or ranges,
partitioning the collected information into a number of different patient information subgroups each identified by a different combination of the two or more possible values or ranges of at least two of the plurality of categorical patient parameters,
generating the plurality of basal rate models based on the collected information in at least one of the number of different patient information subgroups, and
storing the generated plurality of basal rate models in a memory unit.

7. The method of claim 6 further comprising generating a number of sets of the plurality of basal rate models each based on the collected information in a different one of the number of different patient information subgroups.

8. The method of claim 7 further comprising storing the generated number of sets of the plurality of basal rate models in the memory unit.

9. The method of claim 6 wherein the collected information includes a plurality of medical condition indicators each indicative of a medical condition of a different one of the plurality of patients,
and wherein the method further comprises filtering the collected information based on the plurality of medical condition indicators to produce a subset of the collected information that includes patient information only for patients for which the corresponding medical condition is acceptable.

10. The method of claim 9 wherein partitioning the collected information into a number of different patient information subgroups comprises partitioning the collected information from the subset of the collected information into the number of different patient subgroups.

11. A method of generating a plurality of basal rate models that together model a basal rate profile defining a corresponding plurality of basal rates of a diabetes treatment drug sequentially delivered to a patient over a period of time beginning with a first basal rate and ending with a last basal rate, the method comprising:
collecting information in the form of a plurality of patient records each for a different patient to which the diabetes treatment drug has been delivered, each of the plurality of patient records including a reference time within the period of time and a basal rate profile that are specific to the corresponding patient,
aligning the basal rate profiles in the plurality of patient records as functions of the reference times such that in each of the plurality of patient records the first basal rate of the corresponding basal rate profile begins at the corresponding reference time,
generating the plurality of basal rate models based on the patient records having aligned basal rate profiles, and
storing the generated plurality of basal rate models in a memory unit.

12. The method of claim 11 wherein the reference time in each of the plurality of patient records is a time within the period of time that the corresponding patient normally falls asleep.

13. The method of claim 11 wherein each of the plurality of patient records further includes a start time that corresponds to a time within the period of time that the first basal rate of the corresponding basal rate profile normally begins,
and wherein aligning the basal rate profiles further comprises aligning the basal rate profiles in the plurality of patient records further as functions of the start times such that in each of the patient records the first basal rate of the corresponding basal rate profile begins at the corresponding reference time regardless of the corresponding start time.

14. The method of claim 13 wherein the reference time in each of the plurality of patient records is a time within the period of time that the corresponding patient normally falls asleep.

15. The method of claim 14 wherein the period of time is twenty four hours in duration,
and wherein the basal rate profile in each of the plurality of patient records comprises twenty four basal rates each having a time duration of one hour.

16. A method of determining a set of basal rate models that define delivery of a diabetes treatment drug to a particular patient over a period of time, the method comprising:
collecting information from a plurality of patients to which the diabetes treatment drug has been delivered,
generating a number of sets of basal rate models based on the information collected from the plurality of patients,
collecting information that is specific to the particular patient,
determining the set of basal rate models for the particular patient based on the number of sets of basal rate models and on the collected information that is specific to the particular patient, and
storing the determined set of basal rate models for the particular patient in a memory unit.

17. The method of claim 16 wherein the information collected from the plurality of patients includes a plurality of categorical patient parameters for each of the plurality of patients,
and wherein the method further comprises partitioning the information collected from the plurality of patients into a number of different patient information subgroups each identified by a different combination of the plurality of categorical patient parameters,
and wherein generating the number of sets of basal rate models comprises generating each of the number of sets of basal rate models based on a different one of the number of different patient information subgroups.

18. The method of claim 17 wherein collecting information that is specific to the particular patient comprises collecting the plurality of categorical patient parameters for the particular patient,
and wherein determining the set of basal rate models for the particular patient comprises selecting from the number of sets of basal rate models a set of basal rate models that was based on a plurality of the categorical patient parameters that most closely matches the plurality of categorical patient parameters for the particular patient.

19. The method of claim 18 wherein generating a number of sets of basal rate models based on the information collected from the plurality of patients is carried out on a first electronic device or system,
and wherein collecting information that is specific to the particular patient and determining the set of basal rate models for the particular patient are carried out on a second electronic device that is remote from the first electronic device or system,
and wherein storing the determined set of basal rate models for the particular patient comprises storing the determined set of basal rate models for the particular patient in a memory unit of the second electronic device.

20. The method of claim 16 further comprising delivering the diabetes treatment drug to the particular patient according to the set of basal rate models for the particular patient over successive time periods each having duration equal to the period of time.

21. A method of generating a basal rate profile that defines delivery of a plurality of basal rates of a diabetes treatment drug to a particular patient over a period of time, the method comprising:
collecting information from a plurality of patients to which the diabetes treatment drug has been delivered,
generating a plurality of basal rate model sets based on the information collected from the plurality of patients, each of the plurality of basal rate model sets modeling delivery of a different plurality of basal rates of the diabetes treatment drug to a patient over the period of time,
collecting a first set of information that is specific to the particular patient,
selecting one of the plurality of basal rate model sets based on the first set of information that is specific to the particular patient,
collecting a second set of information that is specific to the particular patient,
generating the basal rate profile based on the selected one of the plurality of basal rate model sets and on the second set of information that is specific to the particular patient, and
storing the generated basal rate profile in a memory unit.

22. The method of claim 21 wherein the information collected from the plurality of patients includes a plurality of categorical patient parameters for each of the plurality of patients,
and wherein the method further comprises partitioning the information collected from the plurality of patients into a number of different patient information subgroups each identified by a different combination of the plurality of categorical patient parameters,
and wherein generating the plurality of basal rate model sets comprises generating each of the plurality of basal rate model sets based on a different one of the number of different patient information subgroups,
and wherein collecting a first set of information that is specific to the particular patient comprises collecting the plurality of categorical patient parameters for the particular patient,
and wherein selecting one of the plurality of basal rate model sets based on the first set of information that is specific to the particular patient comprises selecting from the plurality of basal rate model sets the one of the plurality of basal rate model sets that was based on a plurality of the categorical patient parameters that most closely matches the plurality of categorical patient parameters for the particular patient.

23. The method of claim 22 wherein collecting a second set of information that is specific to the particular patient comprises collecting a number of independent variables that are specific to the particular patient,
and wherein generating the basal rate profile comprises computing a plurality of basal rates of the diabetes treatment drug to be sequentially delivered to the particular patient over successive time periods each having duration equal to the period of time, each of the plurality of basal rates of the diabetes treatment drug based on a different basal rate model of the selected one of the plurality of basal rate model sets and on the number of independent variables that are specific to the particular patient.

24. The method of claim 23 further comprising sequentially delivering the plurality of basal rates of the diabetes treatment drug to the particular patient over each of the successive time periods.

25. The method of claim 21 wherein generating a plurality of basal rate model sets based on the information collected from the plurality of patients is carried out on a first electronic device or system,
and wherein collecting the first set of information, selecting the one of the plurality of basal rate model sets, collecting the second set of information and generating the basal rate profile are carried out on a second electronic device that is remote from the first electronic device or system,
and wherein storing the generated basal rate profile comprises storing the generated basal rate profile in a memory unit of the second electronic device.
